(19) United States
(12) Patent Application Publication
(10) Pub. No.: US 2009/0218401 A1
(43) Pub. Date: Sep. 3, 2009

(54) METHOD OF IDENTIFYING AN OBJECT, AN IDENTIFICATION TAG, AN OBJECT ADAPTED TO BE IDENTIFIED, AND RELATED DEVICE AND SYSTEM

(75) Inventors: Peter Malcolm Moran, Singapore (SG); Adrian Paul Burden, Padova (IT); Zhiqian Liang, Singapore (SG)

Correspondence Address: FOLEY AND LARDNER LLP;SUITE 500, 3000 K STREET NW, WASHINGTON, DC, 20007, US

(73) Assignee: Singular ID Pte Ltd

(21) Appl. No.: 12/300,258

(22) PCT Filed: May 11, 2006
(86) PCT No.: PCT/SG2006/000159

§ 371 Date: Apr. 21, 2009

(51) Int. Cl. G06K 7/00

(52) U.S. Cl. 235/439; 235/487; 235/462.01

(57) ABSTRACT

A method of verifying the identity of an object (322) which has at least two sets of identification information (321 and 327) which are each arranged on or incorporated within a different surface of the object and are at a fixed relative spatial position to each other. In order to identify an object, a reading device (324) obtains a first (325) and a second signal (326) from the first and second sets of identification information of the object respectively, determines the relative spatial position between the two sets of information, and determines the signature of the object.

The present invention relates to a method of identifying an object as well as to an identification tag which comprises identification information. The present invention further relates to an object having identification information that is adapted to be identified, a reading device for reading identification features, and an identification system.

Identification technology has undergone rapid growth in recent years, owing partly to the increasing need of preserving the interest of manufacturers and consumers in the face of rampant piracy. The methods by which an object is identified can range from identification tags that contain visually perceptible information such as barcodes, to sophisticated radio frequency identity (RFID) tags which transmit information using electromagnetic waves. Examples of other common devices used for identification or brand protection include holograms and machine-readable tags such as magnetic stripes to fluorescent inks and micron-sized scattered particles or even fibers within sheets of paper or textiles.

One of the chief reasons for the continued interest in identification technology is the rising incidence of piracy of just about all products—the World Trade Organization estimates that 5-7% of all world trade is in counterfeit goods. Items that are commonly counterfeited include personal documents such as passports, certificates, work permits, visas and driver's licenses, financial instruments such as bank notes, credit cards and cheques, engineering components such as oil filters, break discs and gaskets, content, such as software, music and videos, electronic goods such as memory chips and whole computers and televisions, luxury goods such as handbags and perfumes, and biomedical goods such as pharmaceuticals, implants and equipment, just to name a few. The sheer size of the counterfeiting “epidemic”, as it is sometimes referred to, is clear evidence that existing anti-counterfeiting methods are not effective, particularly as copying methods become progressively more sophisticated.

In view of these problems, the need for more secure systems of identification that are specifically adapted to suit different types of items becomes apparent. For example, there is a need to reliably authenticate personal documents such as passports, certificates, work permits, visas and driver's licenses as well as commercial instruments such as ATM cards, credit cards, currency, cheques and other instruments of commercial transactions at the point of transaction. In addition, it would be beneficial to the software and music companies to be able to uniquely fingerprint items such as compact discs (CDs) and digital versatile disks (DVDs) to prevent the propagation of pirated copies. In yet another example, where articles of high commercial value, such as precious stones, artwork, and antiques, are transacted, it is vital that the party receiving such articles is able to ascertain the identity of the articles before issuing credit. Consumers purchasing luxury goods such as branded designer apparel, watches, stationery and leather products, for example, would benefit from being able to determine the authenticity of the goods they are purchasing. At the same time, the identification of fakes that are being sold on the streets becomes feasible on a large scale when the authentication of the identity of a suspected fake only requires one to read the identification information on the object itself.

Product makers typically assign and affix unique identifiers, such as product serial numbers, to each product both as a means of identification. However, a problem facing manufacturers intending to implement any identification security on the objects they manufacture is the difficulty in creating copy-proof identification tags that are also sufficiently versatile to provide unique identifiers to millions of individual items. Presently, authentic serial number codes affixed to an object can be easily copied and used on a fake once it becomes possible to discern the serial number. A single barcode, including the more complex two-dimensional barcodes, can be replicated by copying the printed patterns of the barcode. Due to the ease in reproducing such identifiers, attempts have been made to improve the sophistication of identifiers in order to prevent their duplication and in so doing, not only hinder the counterfeiting of products on which the identifiers are being used, but also provide a means of authentication.

Attempts have been made to embed unique serial numbers as a form of machine readable security data into the product or its packaging in a variety of ways so that embedded security data can be subsequently read and used to authenticate the product and/or control unauthorized use. In the case of software products, for example, the embedded security data may be used to ensure that the user is authorized during installation of the software on the user's machine. In the case of financial or access cards (e.g., debit/credit cards, key cards, corporate badges), the embedded security data may be used to activate the door, terminal or ensuing transaction, for example.

Other copy protection and authentication methods have included printing or stamping microscopic features that are difficult to reproduce, such as optical holograms. For example, U.S. Pat. No. 5,729,365 discloses a microlithographic tag comprising an array of individual computer generated holographic patches having a range of features sizes. The patches contain identifying information which can be read with a laser of a proper wavelength and at a proper angle of tilting.

Yet other methods have made use of materials and inks that exhibit a detectable visual response when subject to a unique physical stimulus, such as fluorescent dye or thermochromic ink. For example, U.S. Pat. No. 6,264,107 describes a marker comprising a phosphorescent material that emits light having wavelengths in the range between about 450 nm and about 1050 nm.

The use of electromagnetic tags or markers for anti-counterfeiting, authentication and tamper-protection is also known in the art. A radio-frequency identification (RFID) tag or label is affixed or embedded in an object. The object can then be scanned by a reader device that can ascertain the identification code of the tag and compare it to a known value in a database (such as that shown in U.S. Pat. No. 6,201,474, for example).

Steganography (also called “data hiding”) is another method for combating counterfeiting and piracy. One particular form of steganography is called digital watermarking, which is a process of creating aberrations in a host signal or host object in order to embed machine-readable identification information into the host. The host may be modified such that the embedded code is imperceptible or nearly imperceptible to the ordinary observer upon viewing or playback, yet may be detected through an automated detection process. A variety of digital watermarking schemes may be used to embed a digital watermark onto any digital or print media, for example through subtle line, word or character shifting of printed characters on a page. Examples of watermark encoding and decoding schemes are provided in U.S. Pat. No. 5,862,260.

Rather than marking the object or article directly, it is also commonly known to affix to the object a label that has physical properties which can be analysed for anti-counterfeiting and authentication purposes. For example, U.S. Pat. No. 4,558,318 describes a verification tag which bears perforations representing machine readable identification numbers.

In the field of biometrics, identification of a person is carried out via a pattern recognition based on his/her physiological characteristics (see U.S. Pat. No. 6,356,649 for instance) which do not change substantially through the person's life. For example, the fingerprint on a person is scanned and stored in a database for subsequent verification. Apart from fingerprint, the patterns of the iris in the eye as well as facial and body features have been used for identification purposes.

The idea underlying biometrics has been extended to non-animate objects such as jewelry. For identifying gems, Gemprint™ technology from Collectors Universe, Inc. uses a low-powered laser to capture the unique reflection and diffraction pattern of a diamond. Due to the minute differences in the cuts put onto a diamond when forming its different facets, unique diffraction patterns are produced by each diamond when a light source is shone through it. The resulting reflection and diffraction pattern is recorded and the image is stored in a database for verifying the identity of the diamond later on.

Despite the existence of these identification methods, specific limitations still exist in them for which continuing efforts are required to overcome them. An objective of the present invention is to provide an alternative method of identifying objects which addresses some of the drawbacks of the prior art methods and devices. This objective is solved, amongst others by the method, object and system as defined in the respective independent claim.

In a first aspect, the present invention provides a method of identifying an object having identification information, said identification information being used to verify the identity of the object. This method comprises:

providing an object having at least two sets of identification information comprising a first set of identification information and a second set of identification information, wherein at least one identification feature of the first set of identification information is arranged on or incorporated within a different surface, side or plane of the object, with respect to at least one identification feature of the second set of identification information, thereby adapting the object to be identified,

wherein said at least one identification feature of the first set of identification information and said at least one identification feature of the second set of identification information are arranged at a fixed relative spatial position with respect to each other, said fixed relative spatial position being used to derive a signature for identifying the object,

providing a reading device, wherein said reading device is adapted to read a signal from the at least one identification feature of each of the at least two sets of identification information arranged on or incorporated within different surfaces, sides or planes of the object, and wherein the reading device is configured such that it defines the spatial relationship between a first discrete area of the first set of identification information to be read and a second discrete area of the second set of identification information to be read, and

determining, using the reading device, at least one characteristic of a property of the at least one identification feature of the first set of identification features, thereby obtaining a first signal,

determining, using the reading device, at least one characteristic of a property of the at least one identification feature of the second set of identification features, thereby obtaining a second signal,

using a processing unit to derive/form/generate at least one signature for the object, using said first and said second signals (and thereby inherently or explicitly the features' spatial relationship).

The fixed relative spatial position at which identification features of the first set of identification information and identification features of the second set of identification information are arranged at with respect to each other, is herein also termed the “features' spatial relationship”. The features' spatial relationship is machine-determinable and is used to verify the identity of the object.

As mentioned, the reading device is configured to define the spatial relationship between a first discrete area of the first set of identification information to be read, and a second discrete area of the second set of identification information to be read. This spatial relationship between the first discrete area of the first set of identification information and the second discrete are of the second set of identification information is herein also termed the “readings' spatial relationship”.

The term “identification information” as used herein refers to any machine readable information that can be (consistently) read. Identification information comprises one or more machine distinguishable “identification features”. Identification features display one or more consistently measurable physical characteristic, such as, but not limited to, magnetic field strength, capacitance, conductance, fluorescence, reflectivity or colour, for example. Therefore identification may be a series of dots, line patterns, a simple timing mark(s), 1-D and 2-D barcodes, holographic features, and random markings such as fibres contained within paper or textiles. Other examples of identification features include magnetic particles, scattered quantum dots, bubbles, voids, physical undulations and roughness, or domains or regions within a continuous material (e.g. magnetic domains). The use of bubbles as identification features is described in US patent application 20030014647. Another example of randomly distributed materials that can form the identification features includes fibres randomly dispersed fibres in a sheet of paper or continuous light pipes with two ends arranged on one or more edges of a layer such as the one described in PCT application WO 87/00604 or the U.S. Pat. No. 4,682,794. Examples of other identification features are randomly distributed materials or particles which include, but are not limited to, the porous materials filled with magnetic or electrically conducting material described in US patent application 2005017082A1 or the international patent application WO 2005/008284, or the particles described in pending PCT application PCT/SG2005/00012, the entire contents of which is incorporated herein by reference. The term “identification information” also encompasses other more specific terms such as “identification tags” or “identification labels” or “identification patterns”. While it is sufficient that the symbol or patterns have distinguishable printed features, it is possible to assign different symbol or patterns with different meanings, such as alphabetical or numerical meaning, so that a series of characters or patterns can be subsequently deciphered to obtained meaningful information regarding the tag or object.

By determining at least one characteristic (e.g. magnitude) of a property of one or more features of a set of identification information, a signal representing the set of identification information is obtained. The term ‘signal’ as defined herein, refers to measurements made by the reading device. In the example of a barcode, the signal that can be obtained from determining the reflective properties across a surface of the barcode when a beam of light passes over the barcode may be the reflectivity signal. In the example of a magnetic layer with random magnetic particles scattered within the layer, the signal that can be measured as a magnetic reading element scans across the layer may be the magnetic field strength. In case, electrically conducting identification features are employed, the electrical field strength may be measured. If optically active particles are randomly dispersed in an identification layer, then fluorescence or luminescence intensity may be measured. Alternatively, if RFID tag is used, then the radio frequency signal produced by the tag may be measured. Other possible characteristics can be measured from other types of identification information.

Identification information may comprise an identification layer in which, at least in part, a plurality of randomly distributed particles is present. The randomly distributed particles may comprise a material that displays one or more consistently measurable physical properties, such as magnetic field strength, capacitance or conductance, for example. Due to the random arrangement of the particles, a signal that is unique to the specific set of identification information can be obtained by determining with a reading device a characteristic of these properties, such as the magnitude of magnetic field strength over a portion of the identification layer. Also herein, “randomly distributed particles” is understood to mean physically separate particles, but is also understood to mean features or variations within a continuous material (so long as these are essentially random or highly disordered). For example “randomly distributed particles” includes voids, bubbles, or magnetic domains with a continuous material, or regions of varying reflectivity, or electrical properties.

In another aspect, the invention provides an identification tag for identifying an object to which the identification tag may be attached. The tag comprises at least two sets of identification information, said at least two sets of identification information comprising a first set of identification information and a second set of identification information each arranged within a different surface, side or plane of the identification tag, and identification features of said first set of identification information and identification features of said second set of identification information are arranged at a fixed relative spatial position with respect to each other, said fixed spatial relationship being used for identifying the object.

In another aspect, the invention provides an identification tag for identifying an object to which the identification tag may be attached. The tag comprises at least a first set of identification information and the object comprises at least a second set of identification information. Once the tag is attached to the object such that each set of identification information is arranged within a different surface, side or plane of the object, the identification features of said first set of identification information and identification features of said second set of identification information are arranged at a fixed spatial relationship with respect to each other, said fixed spatial relationship being used for identifying the object.

Other aspects of the invention are directed to an object containing at least two sets of identification information, an identification system for identifying the object, and a reading device for reading the object's identification features.

In the present invention identification features of at least two sets of identification information are each contained within a different surface, side or plane of an identification tag, or an object, or both, or of two or more objects when they are combined. The sets of identification information and the features' spatial relationship together provide identification data unique to that object for anti-counterfeiting and tamper-proofing purposes (or providing tamper-evidence).

A reading device is adapted to read signals from the sets of identification features and determine their spatial relationship. The signals read from the sets of identification information are combined or linked directly, indirectly or inherently using the features' spatial relationship, so as to form a “signature” for uniquely identifying the object. This combining or linking using the features' spatial relationship means that if the features' spatial relationship is changed significantly the object's signature will be different. A signature derived from an original reading of the sets of identification information can be stored in a data storage means, for example in a memory device that preferably forms a database. This signature is termed the object or tag's “pre-stored reference signature”. Signatures obtained from subsequent readings of the object are compared against pre-stored reference signatures to ensure that the object is genuine and/or has not been tampered with.

A signature may comprise correlated numerical data of the signals which have been obtained from readings of any set of identification information on the object, including correlated numerical data of the first and the second signal, and correlated numerical data of the first, the second and further signals, if more than two sets of identification information are arranged on the object.

Advantageously, the inventors have found that it is difficult to forge two or more separately located sets of identification information sufficiently accurately such that the exact relative spatial position and alignment of the identification features in the original sets of identification information is maintained in the forged copy. Relying on this finding, it is possible to form a unique signature out of the sets of identification information and their features' spatial relationship in order to determine the authenticity of a tag or object. As the relative arrangement between the two sets of identification information can be analysed for any misalignment down to the micro-scale or better, the present invention provides a simple identification method that is virtually copy-proof.

Herein, the term “object” refers to an individual object/tag in which or on which sets of identification information may be incorporated or arranged. The term “object” also refers to two or more objects (including tag or tags) that have been combined in such a way as to effectively form a single object for the purpose of identifying of an item of value. The term “object” will, in certain contexts, refer to an article that is to be identified or tagged with an identification tag.

In the method according to the present invention, an object that is adapted to be identified or made identifiable is provided with at least a first set of identification information and a second set of identification information, and the features' spatial relationship of these at least two sets of identification information are used to ascertain the identity of the object. In this context, an object is adapted to be identified when identification information is affixed on, or incorporated within, the object. The same applies when sets of identification information are formed on an identification tag and then subsequently attached onto an object. In accordance with the above definition, the sets of identification information comprises any machine readable pattern, including optically readable patterns, a magnetic strip providing magnetic field strength patterns, scattered fluorescent particles over a tag surface providing fluorescence intensity patterns over the surface, for example. An object that is not adapted to be identified may comprise intrinsic features—however, in accordance with the definition above, these intrinsic features do not serve to adapt the object for identification.

In one embodiment of the invention that uses an identification layer, the identification layer comprises a plurality of randomly distributed magnetic or magnetisable particles derived from the elements Fe, Ni, Co, their alloys, oxides, mixtures and combinations thereof. As the magnetic particles each exert a magnetic field, the plurality of randomly distributed magnetic particles provides a unique magnetic field strength pattern. Accordingly, the reading of such an identification layer comprises reading the magnetic field strength, thereby obtaining a magnetic field strength signal. It is also possible to use randomly distributed conductive and/or semi-conductive particles or randomly distributed optically active particles having, for example, luminescent qualities in the identification layer. The particles may have a largest dimension of between about 10 nanometres and about 500 micrometers. In a preferred embodiment, these randomly distributed particles may be held together in a host binding material selected from the group consisting of metals, ceramics and polymers and combinations thereof. Published US Patent Application 20050017082 describes such identification layers and method of fabricating them in detail. Further details of identification tags which comprise identification information are also described in detail below.

Given the different possibilities of using different types of identification information (barcodes, magnetic tags, RFID tags, fluorescent particle tags and electrically conductive particle tags), the relative spatial position between identification features of different combinations of different sets of identification information can be used to identify an object, including but not limited to, combinations such as barcode-barcode, barcode-magnetic tag, barcode-fluorescent tag, magnetic tag-magnetic tag, magnetic tag-fluorescent tag, and so on.

Regardless of the type of identification information that is used, both the first and the second sets of identification information are arranged or contained within different sets of surfaces, sides or planes of the object or on a tag or both. Several combinations of arrangements are possible. In one embodiment, the first set of identification information is arranged on a first surface of the object (such as the top surface) and the second set of identification information is arranged on a second surface of the object (such as the lateral surface or the bottom surface). For example, both the first and the second sets of identification information can be printed directly on a surface of an object, or both maybe printed on adhesive sheets and then affixed to the surface of the object. One implementation of such an arrangement in a tag that is to be used in conjunction with this method is a strip having at each end a set of identification features. Such a strip can be folded to form a loop for attachment to a part of an object (see FIG. 13).

In another embodiment, the first set of identification information is arranged on a first side of the object and the second set of identification information is arranged on a second side of the object, said first side and second side being in the same plane. For example, the sets of identification information can be printed on a rod-shaped object or bar shaped object, thereby being on the same cylindrical plane defining the surface of the object; however, they can be arranged on different physical sides of the object.

In a further embodiment, the first set of identification information is arranged in a plane within the object and the second set of identification information is arranged on a surface of the object. For example, in a rectangular block-shaped object or tag, the first set of identification information may be embedded in a plane within the object or tag so that it is visually imperceptible, while the second set of identification information is arranged on the surface of the tag.

In yet another embodiment, it is contemplated to have the first set of identification information arranged on a surface of a tag that is arranged on the object and the second set of identification information is arranged in a plane within the tag. This arrangement is also implemented in the form of a tag which has one of more identification layers sandwiched between sheets of material on which identification information may be present.

The sets of identification may be arranged to the side of an object, such as when arranged on a spherical object, or multifaceted object such as a diamond, identification information arranged on one side of the object may face an opposite direction from identification information that is arranged on another side of the object. In one embodiment, the set of identification information comprises an identification layer arranged on an edge of an object which defines the thickness of the object, such as the flat edge of a credit card, travel ticket, or a compact disc. In such an arrangement, the readable portion of the identification layer is located at its thinnest dimension. This portion is exposed so as to be accessible for reading the identification features contained in the identification layer. More preferably, identification features are read from a track which exposes the thinnest dimension of the identification layer such that identification features are only meaningfully readable from said track. Examples of methods for forming such an identification layer are described below. In this regard, both sets of identification information may be either hidden or covered from view, or it may be fully exposed for reading. If hidden, the identification information can be mechanically exposed. For example, an identification layer may be exposed by any suitable mechanical means, such as simply cutting, polishing or abrading the identification layer or a layer structure, if a support and/or covering layer is used, until the thinnest dimension of the layer is exposed for reading.

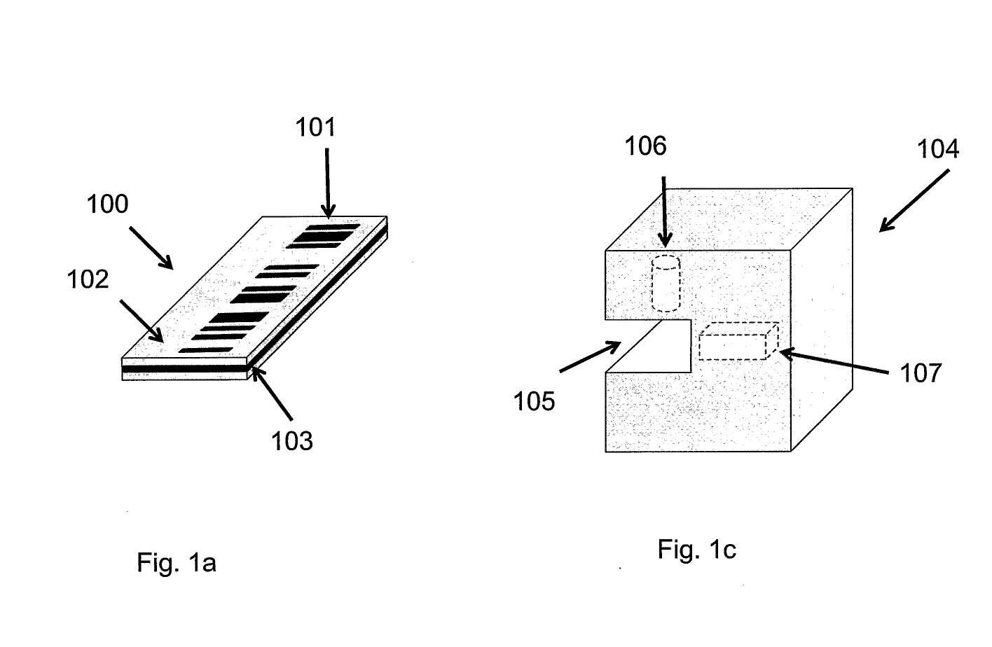

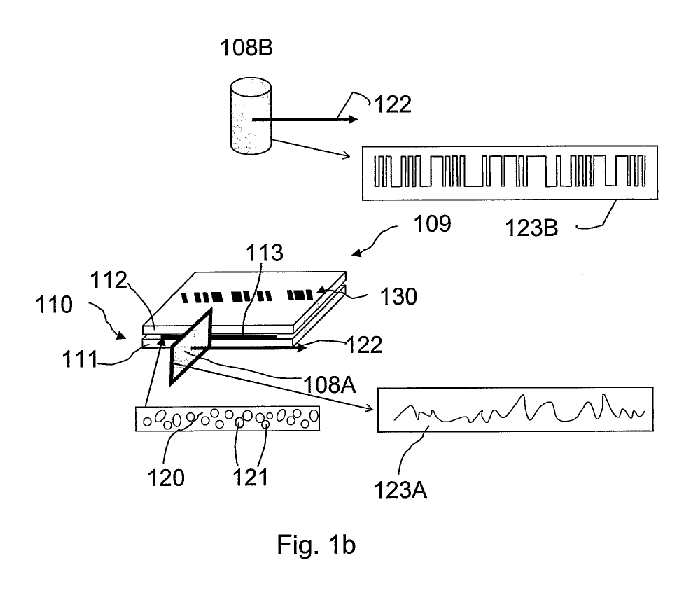

Identification information comprising the above-mentioned identification layer may be solely readable from its thinnest dimension. However, it is also possible that an identification layer is readable from both its thinnest dimension as well as from a “main surface”, from which another set of identification information may be obtained. A “main surface” is defined here as being one of the larger or more prominent surfaces. For example, in FIG. 1a the surface occupied by the barcode symbol is considered a “main surface” under this definition whereas the track exposing the identification layer is a narrow edge and does not constitute a “main surface” under the definition used herein. Thus, in the present invention, a surface with a usually much smaller surface area than a “main surface” area of the object to be identified or the identification tag is generally used as the surface for providing the track that exposes the readable identification layer.

The reading device that is used to read the identification features of each set of identification information is adapted to obtain the required signal from the set of identification information. For example, where the set of identification information comprises a barcode, the reading device being used to determine the characteristic of the properties of the identification features of the set of identification information is adapted to read the identification features, i.e. the black bars, on the barcode. Reading of printed patterns such as barcodes can be carried out with conventional scanners such as laser scanners which can be used to measure reflectivity from a barcode, for example. Where the set of identification information comprises a magnetic strip with random magnetic particles, the reading device being used may comprise a magnetic field strength reader such as a gaussmeter or magnetometer, for example. Fluorescence readings may be obtained from a fluorescence meter; a residumeter can be used for determining static field strength measurements while a transponder can be used to determine an RFID signal, and so on.

The reading device may have one or more reading elements for reading the at least two sets of identification information. For the purpose of reading two similar types of identification information (e.g. two optically readable symbologies arranged on an object), the reading device may comprise only one reading element, in which case reading may have to be carried out sequentially, i.e. the second set of identification information is read after the first set of identification information. However, it is also possible in this case to use a reading device with two similar reading elements, each arranged at a position corresponding to the location of the identification information on the object. Where two different types of identification information are present (e.g. a magnetic strip and an optically readable symbology), the reading device may comprise two different reading elements. However, in other embodiments, where the first and the second sets of identification information are of the same type, the reading device may comprise a single reading element. This single reading element such as a magnetic reading element or a optical reading element can, for example, be movable (either automated or manually moved) between two fixed positions (defined by the reading device) to read each of the two sets of identification information. Thus, in this embodiment these two positions between which the reading element can shift, provides for the configuration that defines the spatial relationship between the two discrete areas of the two sets of identification information to be read. In another embodiment of a reading device with only a single reading element, this reading element is stationary and the reading device is designed such that the reading element receives the characteristic of the identification features from the identification features of each of the two sets of identification information. For example, the reading device could be designed to have an optical pathway, which is, for example, equipped with mirrors, to sent optical characteristic such as reflected light or fluorescence radiation caused by the identification features of each of the two sets of identification information to the stationary reading element. In alternative embodiments, two readers each comprising a reading element may be physically and electrically coupled so as to form a single reading device.

Apart from being adapted to obtain the required signal from identification information, the reading device has, as mentioned above, a configuration which defines the spatial relationship of at least two discrete areas of identification information to be read by the device (as defined previously this is known as the reading's spatial relationship). This may mean that the reading device has its reading element(s) arranged to correspond to the position of each set of identification information on the object. For example, if the first set of identification information is arranged on the side of an object and the second set of identification information is arranged on the top of the object, the reading device may have a first reading element arranged to read the set of identification information off the top of the object, and a second reading element arranged to read the set of identification information off the side of the object (See FIG. 1C). Alternatively, and as explained above, a single reading element, could move between two positions that provide for reading the two sets of identification or a the reading device may comprise optical pathways to direct the characteristic to be read to a stationary single reading element. The reading device generally also defines at least one coordinate of the areas of identification information to be read—for example it can define how far the area is from a corner or edge of the object. In other embodiments, the reading device may define absolute length scales and/or may be complimentary in shape to the object being read.

The relative spatial position between the at least one identification feature of the first set of identification information and the at least one identification feature of the second set of identification information is used, by means of a processing unit, to generate the signature from the first signal and the second signal. This can be done by obtaining the first signal and/or the second signal, for example, as a function of time or in the spatial domain. So doing, a set of values of, for example, the first time domain data and a set of values of the second time domain data is obtained. Data acquired from the first signal and/or the second signal in the time domain or with respect to a relative position, (i.e. in the spatial domain) can be normalized. Alternatively, a mathematical function can be fitted to the data. Forming the signature using the first and the second signal can include determining reference features from the first signal data and using these reference features to normalize or to map the second signal data to a standard spatial domain. The standard domain to which the data is mapped to can be same or different for each object. As described above, the data relates to the characteristic of a selected property of the identification features comprised in the sets of identification information. By associating at least one, a plurality (i.e. at least 2 or more) of, or each identification feature of the first set of identification information (or data read from each identification feature) with at least one, a plurality of, or each identification feature of the second set of identification information that is spatially aligned with it, the relative spatial position between the two sets of identification information can be determined. The term “aligned” as applied to the identification features of the first and the second set of identification information refers not only to parallel or perpendicularly aligned identification features, but includes any other arbitrary alignment between the identification features e.g. the features may aligned at an angle of 45° to each other from the horizontal, for instance. Furthermore, alignment is possible not only with sets of identification information that are of the same physical size, but is also possible with sets of identification information which are of different sizes such that the reading period for each set of identification information may be different (e.g. the electromagnetic signal from a small RFID tag can be associated with the reflectivity signal from a physically larger barcode).

Accordingly, any suitable scheme for associating or correlating the first signal to the second signal based on the spatial alignment between the identification features of each set of identification information may be used. An example of such a scheme may be to correlate data from each signal which represents identification features of each set of identification information that are located at specific positions on a tag/object (spatial correlation). This spatial alignment may also be determined indirectly by associating data points from each signal that are taken at the same time or within very short times (e.g. within microseconds) of each other (temporal correlation). Further examples will be described below.

In one embodiment, the reading of the at least one identification feature of the first set of identification information is timed. Timing the readings of each set of identification information yields time domain data. The term “time domain data” refers to any reading of a physical quantity that is associated with the time at which the reading was taken. Thereby a set of first time domain data is obtained in which the characteristics (e.g. values) of the physical quantities measured from the reading of the first and/or second set of identification information are expressed as a function of time. Accordingly, a timed reading of at least one identification feature of the first set of identification information yields a first set of time domain data, and a time reading of at least one identification feature of the second set of identification information yields a second set of time domain data.

By timing the reading of an identification feature of a set of identification information, for example, timing the reading of the reflectivity value across a barcode, an analogue reflectivity signal may be obtained. This information may be recorded as a set of raw data representing the physical quantity being measured, and a set of corresponding time data at which the measurement took place. By converting the analogue signal into a digital signal, e.g. by using an analogue to digital converter (ADC) to process readings set a predetermined sampling rate, discrete data can be obtained from the readings at specific time intervals. The discrete data can serve a variety of functions, including providing reference markers or timing marks and measuring the feature's spatial relationship, for example. Where markers are represented in one set of identification information, they can serve as reference points from which the relative spatial position of the features from other set(s) of identification information is to be evaluated.

Any suitable method, for example a numerical method, may be used to analyse the data obtained from the first and the second signals by normalizing or fitting. For example, an analogue signal can be modelled/fitted by means of a fitting function which enables the signal to be expressed as a function of time in the form of a mathematical equation. When reading 1D barcodes for instance, the positions of midpoints of the dark areas (e.g. dark bars) on the label may be identified by interpolation functions (explained in more detail later), and the midpoint may be taken to represent the location of a single, dark barcode identification feature.

In certain embodiments, the fitting function may be selected from any suitable mathematical function which can interpolate or extrapolate the data for the first and the second signals. In general, interpolation or extrapolation comprises formulating a mathematical function from a discrete set of known data points obtained from experiments, so that new data points can be calculated from the function. Examples of functions that can be used to model/fit or normalize data include linear functions, polynomials functions, spline functions, spectral functions (e.g. a wavelet function or a Fourier function) and multivariate functions. For interpolation purposes, linear interpolation functions, polynomial interpolation functions and multivariate interpolation functions, for example, can be used.

As said above, one class of polynomial functions that has been found to be effective for interpolation comprises spline functions. A spline interpolation function uses a series of low-degree polynomials as interpolants to model each set of intervals in a piecewise manner over the entire range of data points. The polynomial pieces are chosen such that they fit smoothly together to interpolate the experimental data. For example, when we use a cubic spline to interpolate six points, we may use a piecewise cubic curve to model every two-point interval. In order to string these curves together, we set the second and first derivatives at the endpoints of each piecewise cubic curve equal to that of the adjacent cubic curve's second and first derivatives thus providing for a continuous second derivative. This gives a smooth curve that passes through each point, thus interpolating them. For more information regarding splines, reference may be made to the following standard texts: Bartels, R. H.; Beatty, J. C.; and Barsky, B. A. “An Introduction to Splines for Use in Computer Graphics and Geometric Modelling.” San Francisco, Calif.: Morgan Kaufmann, 1998; de Boor, C. “A Practical Guide to Splines.” New York: Springer-Verlag, 1978; Dierckx, P. “Curve and Surface Fitting with Splines.” Oxford, England: Oxford University Press, 1993.

In a further embodiment, readings are made with respect to time. Correlation of a first set of identification information to a second set of identification information is achieved by first determining reference points from the first signal, and using said reference points to normalize the signal read from the second set of identification features. In this embodiment, the features' spatial relationship may be determined indirectly by interpolating the position of identification features read with respect to the reference features. The normalized signal may be used as the pre-stored reference signature. Each reference point or identification feature may be selected based on a pre-determined criterion. Examples of selection criteria include selecting maxima, minima, or midpoints between maxima and minima in the first time domain data. In this context, the term ‘reference point’ or ‘reference feature’ refers to identification features in the first set of identification information that serve as a node for correlation with an identification feature in the second set of identification information. The term ‘reference’ as used herein does not imply any reference to the object's pre-stored reference signature.

Quasi time-independent correlations can also be carried out by reading the sets of identification information simultaneously. In one embodiment, two independent reading elements (controlled by a central processing unit) in the reading device are each made to read, respectively, the first and the second set of identification information simultaneously, so that the data obtained from the readings can be directly matched to each other (and thus correlated) without having to carry out numerical operations on a set of raw data. By the term “simultaneously”, we refer not only to the concurrent reading of identification features of two or more sets of identification information, each being read with a respective reading device, but also to the reading of data alternately from the first set of identification information and the second set of identification information using a single reading device, as may be limited by the serial processing of a reading device, and thus also alternate reading from the various sensors (i.e. from the various sets of identification features) as the reader moves with respect to an object. In the above description where the “simultaneous” readings are actually alternate readings from different sensors, the readings occur within a very short time of each other (usually within microseconds) so that for the purposes of interpreting the data they are effectively simultaneous.

In some embodiments, the reading of the sets of identification information may be carried out in similar directions, i.e. reading is carried out unidirectionally. Alternatively, readings may also be carried out in different directions.

A processing unit is used to sample the readings of the identification features of the sets of identification information at a suitable sampling rate, or to process readings which are taken simultaneously from two separate sets of identification information when the reading device is moved across the identification information. Examples of a processing unit that can be used presently include any microcontroller, such as 16-bit or 32-bit microcontrollers, available from manufacturers such as ATMEL, Freescale Semiconductors and Analog Devices, for example. The relative speed between the reading element and the identification features, and/or the scanning speed (where a scan of the identification information is made without necessarily moving the reading element) during said reading can be used to determine the sampling rate of the processing unit for acquiring data from said reading. Information about the speed that is derived from reading the first set of identification information by the reading device can also be used to control the sampling speed for acquiring data from a second set of identification information.

In one embodiment, in which the relative speed between the reading element and said first set of identification information, and/or the scanning speed, is determined by the reading device, the first set of identification information comprises a standard format. By “standard format” is meant herein that the identification information comprises a pre-defined format that allows obtaining prediction knowledge about the identification information. For example, a (1D) barcode is such a standard format since it is predefined (known) that the bars are binary (either black or white), that they are also of a standard thickness (i.e. if a thin bar is 1 unit thick then a thick bar is 2 units and a very thick bar is 3 units and there should be no bars that are 2.5 units thick for example). This predefined information of the barcode is known even if the barcode number that is assigned to a particular barcode is not known. Accordingly, a layer with randomly distributed material therein that is made by a process that deliberately results in this random distribution is not a “standard format” as used herein.

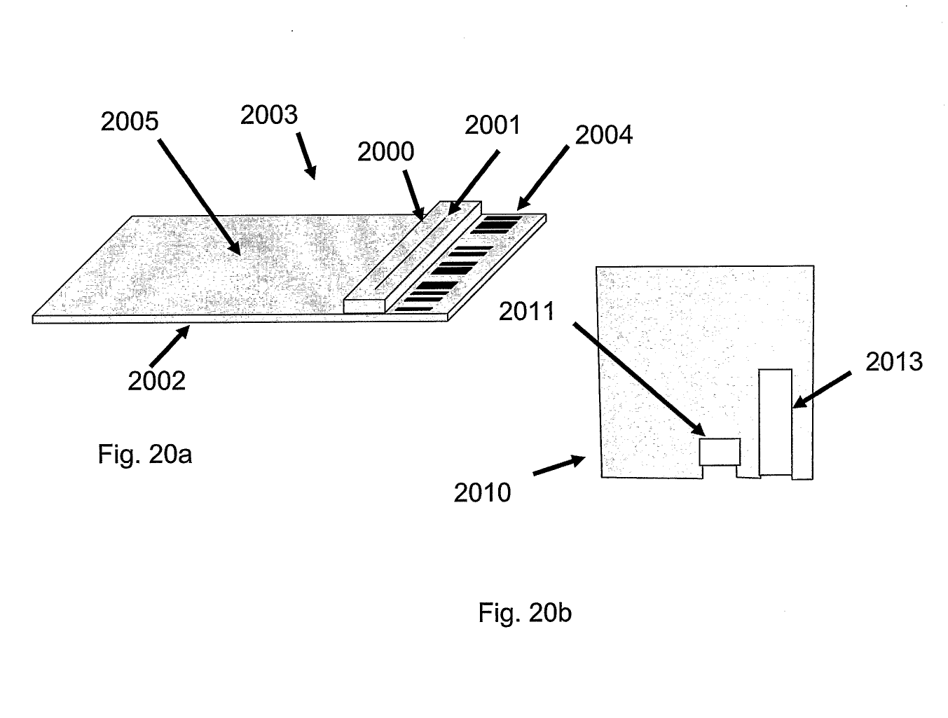

The in-situ control of data acquisition speeds, as described in the two paragraphs above is extremely useful, and sometime essential, in practical situations. For example, the inventors have constructed hand-held reading devices which incorporate a barcode reading element and a magnetic reading element (such as shown in FIG. 20b) used to read barcode and magnetic identification information from objects (such as shown in FIG. 20a). The reading devices work as follows: when the device is brought up to the object, the barcode reading element senses that it positioned over a white reflective surface (i.e. it is positioned on the object before the start of the barcode). When the user swipes the reader across the object the barcode sensor senses the rapid changes between black and white regions which represent the beginning of the barcode. At this point the reading device's microprocessor (processing unit) is programmed to start acquiring (and storing) data from both the barcode sensor and the magnetic sensor. It is evident that this initiation of data acquisition is very important because microprocessor chips generally have limited memory capacities and if too much data is acquired and stored their memory overflows. It is also important to know what speed to acquire data at. For example, if the user is swiping the reading device slowly then the data acquisition should be done relatively slowly because 1) even slow acquisition speeds will be able to sample sufficient data for an accurate reading of both the barcode and magnetic identification information, and 2) if the data acquisition is not relatively slow the memory of the microprocessor may overflow before the reading is finished. Usually with a manual swipe, however, the swipe speed (i.e. also the relative speed between the reading element and the set of identification features that is read) changes significantly from the start of the reading to the end of the reading. I.e. if the user is starting the swipe from a stationary position the reading device will typically be moving very slowly in the beginning, but during the swipe the reading device is usually accelerated throughout the reading until, towards the end of the reading the device is moving with considerable speed. If the data acquisition (and storage) speed is kept at the relatively slow speed defined at the beginning of the barcode reading then it is likely that, by the time the device is nearing the end of the relevant identification information, the data acquisition speed will be too slow to acquire sufficient data to adequately read the sets of identification information. Consequently by using the methods of this invention to update and change data acquisition speeds during the reading, it allows appropriate data acquisition (and storage) speeds to be used throughout the reading. If, as described here, the swipe speed of both elements is the same (or at least related to each other), then the swipe speed determined from the first set of identification information (in this case the barcode) can be used to adjust the data acquisition speeds for the reading elements reading both sets of identification information. In this context it is mentioned, that for reading a signal either the reading device and thus the reading element(s) may be moved and the object adapted to be identified may then be resting or that conversely, the object may be moved and the reading device and the reading element(s) can be a fixed. It is of course also possible to move both reading device and object while reading the identification information.

The processing unit may further be adapted to update the pre-stored reference signature by storing data of a read signature as an updated pre-stored reference signature for a future verification check. When using the identification tag or the object adapted to be identified for a longer period, abrasion of the track or the entire identification layer may occur as a consequence of the intense use of the identification tag. Such an abrasion may cause the characteristic signature to be changed. In a static system, in which the pre-stored reference signature would always stay constant, such an abrasion effect may have the consequence that an identification tag is not recognized by the system. Thus, the dynamic system that is used in one embodiment of the invention updates changes in the detected signature and stores this updated signature as the pre-stored reference signature. Thus, small changes with time due to abrasion of material of the identification layer can be taken into account, thus improving the functionality of the system, since an erroneous classification of a tag or the object to be non-valid as a consequence of abrasion is avoided.

Data derived from the reading of the sets of identification information may be stored in a data storage medium such as a hard disk or a memory chip. The data may be stored as raw data, compressed data and/or encrypted data. Storage enables a processing unit to subsequently carry out any required mathematical procedure on the data and thereby determine the relative spatial position between the first and the second sets of identification information, or when carrying out authentication, to determine the match between a set of freshly read signature and a pre-stored reference signature.

It is not necessary that the pre-stored reference signature be stored permanently in the memory of a reading device. Rather, the reading device can be designed such that it is able to receive the pre-stored reference signature that is stored in a remote data storage medium that can be accessed from a local area network (LAN) or a wide area network (WAN), such as the Internet, for example. Alternatively, the reading device may be able to receive the pre-stored reference signature that is stored in the object to which the tag is attached or the object to be identified. In this context, it is noted that the object or the tag may additionally have stored further information, for example, the price of the object, the manufacturer name thereof or the like. Such information may be included in a conventional bar code, a two-dimensional bar code, a magnetic strip or a memory chip. The reading device may thus also be adapted to read a conventional barcode, a two-dimensional barcode, a magnetic strip or memory chip.

More commonly however, the reading device can be designed such that it is able to send the read signature to a remote device (such as a computer) that stores the pre-stored reference signature. That remote device compares the signatures and sends back a response identifying the item and providing any additional information that may be required. Often the actual reading device itself communicates with the remote device via a communication device (e.g. a cellular phone, a computer that is connected to the internet, or through a fixed line communication device). In this embodiment the remote device need not send a message back to the reading device itself, but rather the message may be sent back to the communication device which then displays the information to the user. For example, if the reading device communicates via a cellular phone, then the remote device need only send back a message to the cellular phone. The cellular phone may display the information to the user without sending any of the information back to the actual reading device itself.

In order to provide an even more robust system that can handle errors, either one or both of the first and/or the second set of identification information may include error handling information for determining whether the read values of the first set of identification information and/or the second set of identification information correspond to their actual values. This may be achieved by including checksum values into the sets of identification information, as will be described later in the examples below.

In one embodiment, the identity of an object is authenticated or verified. The step of verifying or authenticating the identity of the object having identification information may be achieved by matching the signature read from the object against pre-stored reference signatures stored on a database. In addition the verification may include checking individual signals obtained from readings of identification features of either set of identification information (i.e. matching a read magnetic signal against an authenticating magnetic signal) or checking any other information within the identification information (e.g. numerical meaning such as 0, 1, 2, 3, 4, 5 to 9 assigned to various barcode patterns).

As explained above, the reading device is configured such that it defines the spatial relationship between a first discrete area of the first set of identification information to be read and a second discrete area of the second set of identification information to be read (as defined previously this is termed the readings' spatial relationship). Each discrete area may comprise a partial portion of the whole set of identification information to be read, or it may comprise the entire portion of the whole set of identification information to be read. When reading the sets of identification information for the purpose of establishing the pre-stored reference signature, a signal from the entire portion of the identification information may be read for the purpose of completeness. However, when carrying out verification later on, it is sufficient to read a signature from partial portions of the sets of identification information. This read signature correlates with a fragment of the pre-stored reference signature, and can be matched against said fragment.

It is also possible where the reading device obtains analogue signals from reading the first and the second set of identification information that authentication may comprise checking the graph representing the read signature in the time domain and matching it against a time domain graph representation of the pre-stored reference signature. Subsequently, the area of overlap between the graph representing the read signature and the pre-stored reference signature is calculated. Given possible random and systematic errors in the reading, the graphs may not match perfectly, so a threshold matching value may be set. If the read signature differs from the corresponding pre-stored reference signature by more than a predetermined threshold (i.e. the amount of overlap is not sufficiently high, say for example, the difference between the signals is 0.1%, 1%, 3%, 5%, 10%, 20% or any other value that is regarded to be appropriate for identification purposes), then the authentication fails. Alternatively, authentication may also be carried out in the absence of an analogue signal. In this case, a signature from simultaneous readings of the first and the second set of identification information can be checked directly against the pre-stored reference signature without having to determine the area of overlap between read signature and the pre-stored reference signature. The pre-stored reference signature may be stored in any suitable data storage medium (typically a memory chip or hard disk drive) and most preferably accessed remotely using, any method that is suitable for this purpose, For example, remotely accessing the data storage medium can be carried out using the internet (including mobile access such as General Packet Radio Service, GPRS, protocols), a fixed line access, a local area network, a bluetooth protocol, a short messaging service (SMS) or a multimedia messaging service (MMS) signal, to name only a few possibilities.

In order to ascertain that only a match that is accurate within several millimetres, or less than several hundreds of micrometers, or several tens of micrometers, or preferably several micrometers, is obtained, the resolution of the readings of the signals as provided by the reading device should preferably be high.

Yet another embodiment of the invention includes storing more than one pre-stored reference signature for the object. When the object's signature is read subsequently the read signature can, for example, be compared against all the pre-stored reference signatures for that object or may be compared against all pre-stored reference signatures stored in the database. For example when reading the signatures to be used as the pre-stored reference signatures for the object different reading devices, that means at least two (a plurality) reading devices may be used. The plurality of the reading devices may be configured such that each of them define the spatial relationship between the first discrete area of the first set of identification information and the second discrete area of the second set of identification information differently. This difference in the configuration can either be inherently or deliberately introduced. For example, the reading elements of the various reading devices may be purposefully slightly misaligned with respect to each other. This means that the reading's spatial relationship for each reading device would define a slightly different. Consequently the signature from each reading device would be slightly different. By storing all these pre-stored signatures and using them for subsequent verification of the object it makes the verification more robust. For example consider reading a track of identification features. If the reading element of a first reading device is perfectly aligned, that provides a signature which can be called the “aligned signature”. If the reading element of a second reading device is slightly misaligned (for example, by about 1 micrometer, 10 micrometers, 50 micrometers or 100 micrometers) to the left, that provides a signature which can be called the “left signature”. If the reading element of a third reading device is slightly misaligned (for example, by about 1 micrometer, 10 micrometers, 50 micrometers or 100 micrometers) to the right, that provides a signature which can be called the “right signature”. By storing the aligned signature, left signature and right signature as the pre-stored reference signatures this increase the robustness of the method and system as described below. If many reading devices are being manufactured for commercial sale, there will be certain tolerances and variations between each device. Assuming the maximum misalignment allowable in the manufacturing process is ±50 micrometers, then by storing one or more sets of pre-stored reference signatures corresponding to misaligned readings (including misalignments of at last ±50 micrometers) it means that even the most misaligned production reader still have a corresponding pre-stored reference that would match well with the read signature. A further example of the use of using a plurality of reading devices for deriving more than one pre-stored reference signal is if, the reading elements themselves have some variation in their characteristics (e.g. if magnetic sensors have varying sensitivities). By using a set of reading devices with a range of reading elements the spectrum of signatures possible with the family of reading elements can be recorded. In this embodiment, a subsequently read signature may thus be compared with at least some of with all of the pre-stored signatures that are associated with a particular object or with a family of objects.

In a further embodiment of the invention, in which a barcode or another serialized identification information such as a serial number, binary or hexadecimal information, or an alphanumeric code (e.g. a name) that has been assigned to the object is used as one of the sets of identification information, and if the reading device does not fully, completely or correctly read said barcode or serialized identification information, the processing unit is able to regenerate missing parts of the read signal based on supplementary information that is keyed in or scanned in separately. For example if the identification information is a barcode and an associated number, the barcode can be scanned with an alternate device and the associated number can be used as the supplementary information to regenerate data or important components (such as reference points) missing from parts of the read signal. The regenerated data or component is then used to form a signature for identifying said object.

In a further embodiment, the barcode or the other serialized identification information is used as a primary key with which the pre-stored references signatures are stored and/or retrieved.

Although the invention has so far been described in relation to a first and a second set of identification information, it is possible to include one or more further sets of identification information on the object. The further set or sets of information may be arranged on any surface, plane or side of the object including the surfaces, sides or planes containing the first two sets of identification information. Alternatively, this at least third set of identification information can be arranged on or included into a third surface, plane or side of the object that is different from the one in which the first and second set of identification information is arranged on or incorporated in. By having a further set of identification information, the security of the identification information becomes stronger since it may be necessary for all three or more sets of identification information to be arranged in a specific relative spatial position with respect to each other. In this embodiment, the identification features of the further set of identification information are arranged at a fixed further relative spatial position to identification features of said first and said second set of identification information, and in order for an object to be identified using the present method, the relative spatial position between the identification features of the further set of identification information may be used to tally with the features of the first set of identification information and the further set of identification information may also be used to tally with the second set of identification information, thereby effectively establishing two or more levels of security for arriving at an authentication.

The present invention is applicable to any type of object that may benefit from having an authenticity or identification label, including jewelry, designer label apparel, leather goods, high-end luxury watches, as well as compact discs, digital video discs. Other objects include engineering components, textiles, the packaging around an object, a seal to a container or vessel, a credit card, a certificate, a bank note, a security access card, a vehicular key-card, a passport, an identity card, a lead frame, an electronic device package, or a media disk, or combinations thereof (for example a product and its packaging combined).

In other aspects, the invention provides for an identification tag to which the method of identification as described above is applicable, as well as to an object that is adapted to be identified according to the method. In the following, preferred embodiments of the identification tag and the object of the invention are described. These embodiments are also applicable to the reading device, the identification arrangement, the identification system, the method for forming an identification tag and the method for reading identification information.

In accordance with the present invention, an identification tag is provided for identifying an object according to the method of the invention. The identification tag comprises at least two sets of identification information comprising a first set of identification information and a second set of identification information. The first set of identification information and the second set of identification information are each arranged within a different surface, side or plane of the tag or object. Identification features of the first set of identification information and identification features of the second set of identification information are arranged at a fixed relative spatial position with respect to each other, said fixed relative spatial position being used to form/derive or generate the signature for identifying the object.

In one embodiment, at least one set of identification information comprises an optically readable pattern. Any optically readable pattern can be used for this purpose, including any variety of printed symbols such as printed dots, a matrix of consecutive numbers, 1-dimensional barcodes, and 2 dimensional barcodes such as Aztec Code, Code 1, Code 49, PDF 417, QR Code, Super Code, and Ultra Code, for example.

In another embodiment, at least one of the first set of identification information and the second set of identification information is derived from at least one identification layer in which readable identification features are located. For this purpose, the identification layer may comprise a layer of any type of suitable material or combination of materials having one or more properties that are quantifiable in terms of a measurable physical quantity.

The identification layer(s) may comprise, at least in parts of the layer(s), a plurality of randomly distributed particles. In some embodiments, the identification layer comprises a host material having pores, wherein at least some of the pores contain the particles. As explained below the particles may consist of a magnetic or magnetisable material or of a substantially electrically conducting material. In other embodiments, the particles may be randomly dispersed in a matrix or the particles may be provided by sputtering/ion implantation (cf. also Examples). By providing such a (highly) disordered structure with particles to define the identification features in the identification layer, the information can only be imitated with extremely high effort and/or cost thereby improving the security of the identification system.

In one embodiment, the identification information comprises, at least in part, a plurality of randomly distributed magnetic or magnetisable particles. By implementing magnetic (or magnetisable) particles as randomly distributed and/or oriented particles, a magnetic read head can be used as a reading element that moves along the track that exposes the identification layer, thus reading a signal from the identification features that is formed from the magnetic field distribution caused by the magnetic (or magnetisable) particles, thus providing an inexpensive and highly reliable identification structure.

Any material exhibiting magnetic properties can be used in the identification layer, including but not limited to magnetic materials such as ferrimagnetic materials, antiferromagnetic materials and ferromagnetic materials. Magnetic materials used include but are not limited to ferromagnetic materials such as Fe, Ni, Co, Gd, Dy, the corresponding alloys, oxides and mixtures thereof, and other compounds such as MnBi, CrTe, EuO, CrO₂ and MnAs. Other materials influenced by magnetism are also contemplated. Examples of such materials include ferrimagnetic materials e.g. spinels, garnets and ferrites such as magnetite. Other materials commonly used in magnetic media, such as alloys of Ce, Cr, Pt, B, Nd (e.g. Nd—Fe—B, Nd—Fe—Co—B, Nd—Pr—Fe—Co—Ti—Zr—B), Sm (e.g. SmCo₅), and alloys such as, AlNiCo, Permalloy and MuMetal are also contemplated.

In order to support the magnetic particles, a supporting layer maybe arranged below the identification layer. Additionally, the tag or the object may comprise a cover layer, so that the identification layer is arranged between the support and the cover (top) layer. In principle, every material that is compatible with the identification layer can be used as a support and/or cover layer. Examples of suitable materials include, but are not limited to plastics, metals, ceramics, textiles, natural materials such as leather or wood and combinations thereof. Examples of suitable plastics include polymeric materials such as polyethylene, polypropylene, polyester, polyether, polystyrene, polycarbonate, poly(meth)acrylate that are commonly used for the production of plastic articles such as bags, credits cards, packing materials, sheets etc. Suitable ceramics include, but are not limited to, glass, alumina, silica, bone china, enamels, and vitreous frits.

By the use of the support layer (in case of a two layer structure) or the sandwich structure (in case of a three layer structure), the identification layer is structurally supported and may also be electromagnetically shielded from below and, in the case of the sandwich structure, shielded from the top.

The layer structure of the identification tag may comprise at least one further identification layer arranged between said bottom layer and said top layer. By providing one or more additional identification layers, the identification features can be divided in a plurality of identification layers, thus further increasing the security, since the effort needed to imitate the information included in the identification layers is thus significantly increased. Moreover, this measure can introduce redundancy in the system, further increasing the reliability of the identification tag.

The layer structure may comprise at least one intermediate layer arranged between said identification layer and said further identification layer. By using this configuration, the different identification layers may be separated spatially from one another allowing separate and/or simultaneous reading of the information located in said identification layer(s). Thus, a further redundancy may be included which also improves the reliability of the identification tag or object of the invention.

In a further embodiment in which an identification layer is present, the tag or the object of the invention may also comprise an alignment layer arranged between the top and the bottom layer that facilitates the alignment of a reading element during the process of reading the identification features.

The randomly distributed magnetic particles may be provided in a porous host material in which the pores of which are at least partially filled, the host material is a substantially non-magnetic material. In general, any porous host material that is at least substantially non-magnetic (magnetically inert) or substantially electrically insulating can be used in the present invention. Usually, this host material has good mechanical, thermal and chemical stability in order that migration of the material in the pores to other regions of the host material is prevented or negligible. In addition, the host material's stability minimizes oxidation and unwanted chemical modification of the material in the pores. Such properties enable the magnetic, electric or electromagnetic signal obtained from the tag to remain uniquely identifiable. A suitable host material can, for example, comprise porous alumite prepared by the anodisation of aluminium films as described in U.S. Pat. Nos. 5,139,884, 5,035,960 or Nielsch et al., Journal of Magnetism and Magnetic Materials 249 (2002) 234-240. Thus, the host material of the tag can be alumina.

Other suitable host materials include porous polymeric films (usually bi- or tri-block copolymers where one component has been selectively removed) or porous semi-conducting materials such as porous silicon or porous III-V materials (see, for example, Föll et al., Advanced Materials, 15, 183-198 (2003)). Examples of III-V materials suitable for use as a porous host material in the present invention include GaAs, InP and AlAs. Another suitable host material is zeolites. Examples of suitable zeolites include any one of the members of the zeolite mineral group, for instance clinoptilolite, chabazite, phillipsite and mordenite. Other suitable porous materials include inorganic oxides such silicon oxide, zinc oxide and tin oxide.

Where a set of identification information comprises magnetic particles, the reading of such a set of identification information may comprise reading at least one characteristic of the magnetic field produced by the magnetic particles. The magnetic field pattern would be highly dependent on the disorder of the magnetic particles in the identification layer. In this case, the disorder may be related to at least one of the properties of the identification layer, for example, size, shape and orientation of pores, inter-pore distances, percentage of pore filling and crystal orientation of magnetic material in the identification layer. For example, if a porous host material is used the disorder can be a characteristic of the host material alone. As an example, a host material can be used that has different pore sizes and interpore distances, and the pores of this material can be (equally) filled with a magnetic material. It is also possible to use a host with ordered pores in which the disorder is created by varying the filling degree of the material within the pores. It is of course also possible to use an identification layer with a disordered structure and also vary the percentage of filled pores or (in the case of magnetic material) the crystal orientation of the material within the tag, for example. The above properties which can be manipulated to produce disorder in the identification layer of the tag or the object can also be considered as degrees of freedom.

In one embodiment the identification layer is subjected to a magnetic field prior to each determination of the at least one characteristic of the magnetic field (the signal) of said portion of the track. In this embodiment, the magnetic material within the identification layer, can be remagnetized under the magnetic field before each reading. This increases the magnetic field signal of the track for easy reading. For this purpose, a uniform but also an inhomogeneous magnetic field can be used to re-magnetize the identification layer, such as that produced by simple bar magnets, or the magnetic field generated from solenoids or combinations of magnets.

Additionally or alternatively, the identification tag or object of the invention may comprise a plurality of conductive or semi-conductive particles. Electrically conducting materials include metals, such as but not limited to Cu, Sn, Fe, Ni or alloys thereof. Examples of semi-conducting materials include (poly)silicon, gallium arsenide, gallium nitride, platinum silicide, silicon nitride or sichrome (SiCr) to name only a few. According to this embodiment, a magnetic read head can be used as a reading element for sampling the identification layer to read the identification features that are formed from an electromagnetic field distribution caused by passing current through at least some of said particles. Similarly, an electrical parameter like the resistivity, conductivity, impedance, or the like of the randomly distributed conductive or semiconductive particles as a function of position within the identification layer may be detected using a suitable reading device (such as a conductive sensor). In the case of a porous host material the pores of which can be filled with electrically conducting particles, any of the host materials listed above in connection with the magnetic particles and which are substantially insulating may be used.

In addition or alternatively, the identification tag or object may comprise an identification layer comprising a plurality of optically reflective, absorptive or active particles. Randomly dispersed optically readable identification features can include, for example, fibers contained within paper, optical fibers or light pipes or even randomly distributed bubbles within a transparent polymer. By ‘optically active’ in the present application, it is meant particles that change the wavelength and/or plane of polarisation of light that is transmitted through or reflected from them. According to this embodiment, an optical detector can be used as a reading element for sampling the track formed from the identification layer to read the identification features. These identification features may be formed from, for instance, particles that fluoresce at a specific wavelength, chiral particles that change the plane of polarisation, or a mixture of particles that fluoresce at different wavelengths and/or change the plane of polarisation of interacted light, to name only a few possibilities.

The invention may also include a combination of magnetic and/or magnetisable and/or conductive and/or semi-conductive and/or optically active particles to further improve the reliability and the security of the system. In one case, for instance, a combination of an optical verification and a magnetic verification can be implemented. Typically, the average particle present in the identification layer may have a largest dimension (but not limited to) of between about 10 nanometers to about 500 micrometers.

In yet a further embodiment of the invention, the identification tag or object contains a plurality of identification layers each comprising identification features, wherein each identification layer is readable independently from other identification layers. By reading individual layers, different kinds of information can be located in the identification tag or the object of the invention (e.g. identification features and additional information like a price of a product to which the tag may be attached or background information concerning such a product).

In a further embodiment, one or both of the sets of identification information is/are covered by a protective coating. In principle, every material that is suitable for physically protecting the identification information from damage (for example, by chemical and/or mechanical degradation) can be used, as long as this material does not prevent at least some of the identification features from being read. Examples of suitable material that can be comprised in the protective coating include, but are not limited to, polymeric coatings such as Teflon coating, a rigid polymer, a sol gel or vapour deposited material such as an oxide, nitride, amorphous diamond, a diamond-like material (film) such as diamond-like carbon, tetrahedral amorphous carbon or a spun-coated lacquer. This protective coating (layer) may be a “hard” material. A “hard” material is defined herein as a material preferably having a bulk yield stress of 50 mega-newtons per square metre, i.e. 50 MN/m², or more. An example of a suitable polymer that acts as the hard material is poly methyl methacrylate which has the advantages of being tough and transparent. A single coating layer of poly methyl methacrylate can be produced by dip or spin coating the tag with a solution of monomeric methyl methacrylate. The monomer solution is polymerized during or after coating.

Methods for forming various embodiments of the identification tag or object as disclosed above will now be described by way of example. These embodiments are also applicable to the reading element, to the identification system, to the identification arrangement and to the method for reading identification information.

One of the embodiments of an identification tag which comprises a set of identification information having an identification layer arranged on an edge of an object which defines the thickness of the object and in which the readable portion of the identification layer is located at its thinnest dimension may be manufactured by forming a cover layer arranged on top of the identification layer. In addition a layer structure can be formed in which the at least one identification layer is arranged between a bottom layer and the top layer. In so doing, a laminated structure, for example, may be produced by having an identification layer sandwiched between a bottom layer and a top layer, and located at the edge of the sandwiched layers is a track which exposes the thinnest dimension of the sandwiched identification layer. The track may be formed by any suitable technique, for example, by cutting, abrading and/or polishing, to name only a few.

The laminated structure may be cut into different parts, wherein each of the parts may form a separate identification tag or object. The cut edges then contain the tracks that expose the thinnest dimension of the identification layer comprising the readable identification features.

As described above, the identification layer may comprise, at least in part, a plurality of randomly distributed particles. The identification layer may be formed using a plurality of randomly disordered structures/particles manufactured by forming a porous matrix and filling pores of the porous matrix with suitable material to create said disordered structures/particles.

Such a porous matrix, i.e. a solid body having a lot of randomly distributed pores, may form the identification layer, for example if the porous matrix is made of a magnetic or magnetisable material, and the voids or pores lead to the modulation of the detected signal derived from the information layer. Alternatively, where the porous material is non-magnetic, then pores are filled or at least partially filled with a magnetic or magnetisable material. Other types of materials may also be used to fill the pores, including semiconductor material, electrically conductive material, as well as optically active materials.

Alternatively, the identification structure may be manufactured by implanting ions on the porous matrix or a substrate. According to this embodiment, a statistically distributed arrangement of implanted ions that have then been thermally annealed is typically used for forming the identification structure. This random distribution is a result of the random coalescence of the implanted ions after thermal annealing.

Alternatively, the identification structure may be manufactured using a phase separation of an immiscible binary polymer. According to this embodiment, a two phase system is used for forming a layer, and then the two phases are automatically separated. One of these phases may be removed and the resulting cavities (or pores) are then used as locations where material for forming part of the identification layer can be introduced.

A further aspect of the invention includes a reading device for reading identification features in a first set of identification information and a second set of identification information on a tag or an object to be identified. Such a reading device comprises at least one reading element adapted for reading the first set of identification information that is arranged on or incorporated in an object, and at least a second reading element adapted for reading a second set of identification information. The reading device is adapted to read at least two signals from at least two sets of identification information arranged on or incorporated within different surfaces, sides or planes of the object.

Another aspect of the reading device is that its configuration defines the spatial relationship of at least two discrete areas of identification information to be read. In other words, the reading elements in the reading device are fixedly positioned with the reading device such that they each scan at a specific position on the object corresponding to where each set of identification information would be located.

In one embodiment, the reading device further comprises a processing unit for correlating or associating the first signal and said second signal, thereby obtaining information about the relative spatial position between the identification features of the first set of identification information and identification features of the second set of identification information. The processing unit may comprise 1 or more microcontrollers for processing the read signals, such as 16-bit or 32-bit microcontrollers, available from manufacturers such as ATMEL, Freescale Semiconductors and Analog Devices, for example.

In another embodiment, the reading device further comprises a guiding means for guiding said first and said second reading elements over the first and the second sets of identification information. The guiding means may comprise a slot adapted to receive a portion of the object.

In yet another aspect, the invention is directed to an identification system for identifying an object. The system comprises an identification tag according to the invention that is used for identifying an object to which said identification tag may be attached; and a reading device according to the invention for reading identification information encoded in the identification tag.

In actual implementation, the present system may be used to establish manufacturing pedigree of a product. One illustrative application is in establishing pedigree of a pharmaceutical drug. Pharmaceutical pedigree helps to maintain the pedigree of a pharmaceutical drug by tagging raw materials used in the manufacture of a pharmaceutical drug as well as tagging the packaging of the end-product with identification tags according to the invention each possessing a unique signature. By implementing checking measures during the manufacturing process, starting with the delivery of raw materials to the final delivery of the product onto the shelves of retailers, this system allows the entire supply chain to be tracked and traced.

In one embodiment, raw materials are placed into barrels tagged with identification tags according to the present invention. The signature of each uniquely identified barrel is recorded in a database which is accessible either on a local network or on a wide area network. Reading devices are located in the raw materials manufacturing facilities so that the incoming barrels can be read and its departure from the raw materials manufacturing facilities can be tracked and updated on the database. Once the raw materials from various locations arrive at the central pharmaceutical drug production facilities, the arrival of the barrels are read and recorded on the database. In this manner, all the raw materials going into the pharmaceutical drug is accounted for. After the pharmaceutical drug is produced, every single bottle in which it is packaged is also tagged and the signatures are once again read and stored in the database. After delivery of a shipment of these bottles to a wholesaler, the wholesaler may then access and query the database to determine that the bottles he is receiving matches with those that the manufacturer has recorded on the database (namely the authentication data).

Thus, in another embodiment, the identification system further comprises a computer program capable of processing queries from a user attempting to authenticate read signatures when verifying the identity of an object. Such a program may also be able to carry out a standard query on a database containing authentication data. A computer program may be used to process queries from a user attempting to authenticate read signatures. The computer program may incorporate any method suitable for determining a match between read signatures and the pre-stored reference signatures.

These aspects of the invention will be more fully understood in view of the following description, drawings and non-limiting examples.

Illustrative embodiments will now be described by way of non-limiting examples only, with reference to the accompanying drawings, in which:

FIG. 1a shows a perspective view of an identification tag; FIG. 1b shows the reading of the identification tag, and FIG. 1c shows a perspective view of a reading device to be used for reading identification information on the identification tag;

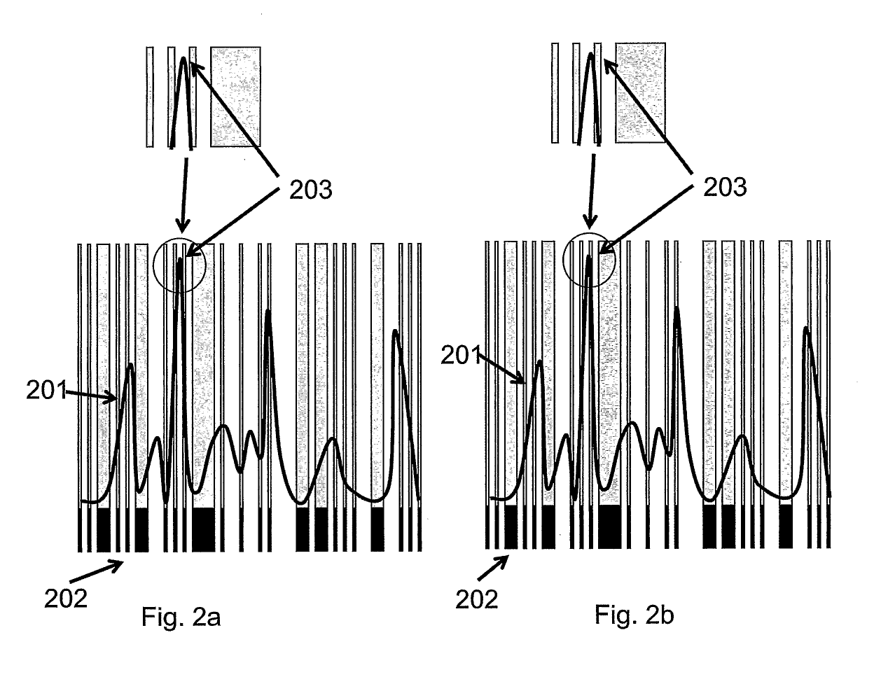

FIG. 2a illustrates an analogue signal obtained from reading magnetic data from identification features comprising randomly dispersed magnetic particles. The illustration shows the analogue signal plotted against the black and white bars of a 1D barcode; and FIG. 2b illustrates the mismatch between the analogue signal and barcode bars when the identification features are misaligned.

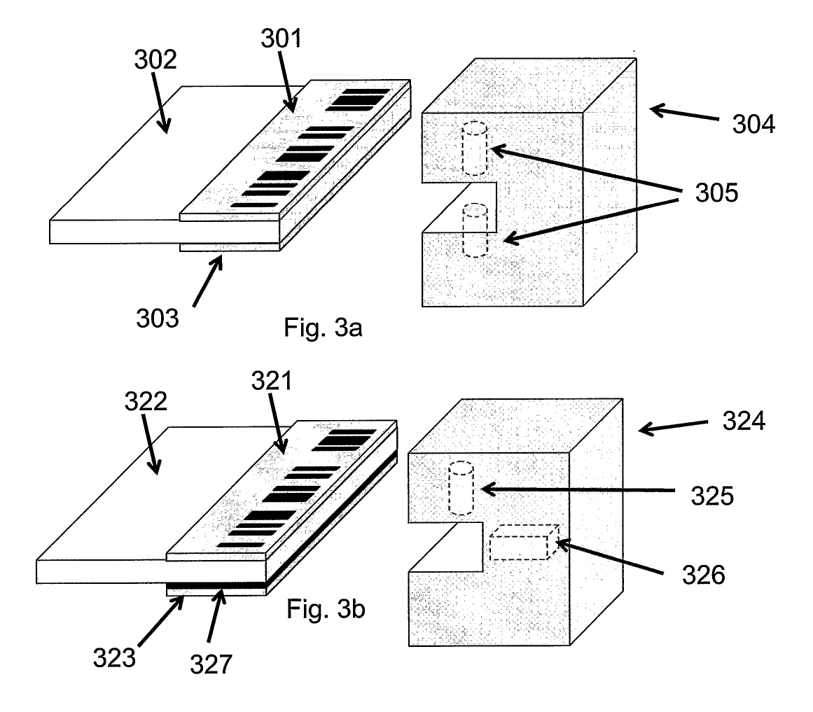

FIG. 3a illustrates an arrangement in which two optical tags sandwich an object, FIG. 3b illustrates an arrangement in which an object is sandwiched between an optical identification tag and an identification layer.

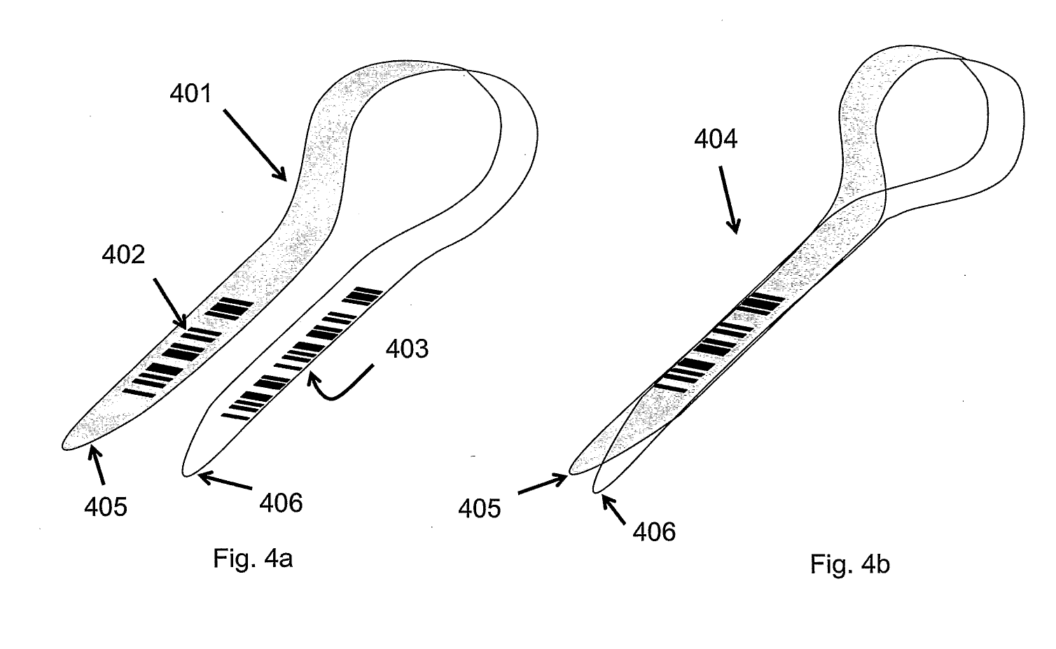

FIGS. 4a and 4b show a preferred embodiment of a tag having the form of a strip that can be arranged into a loop.

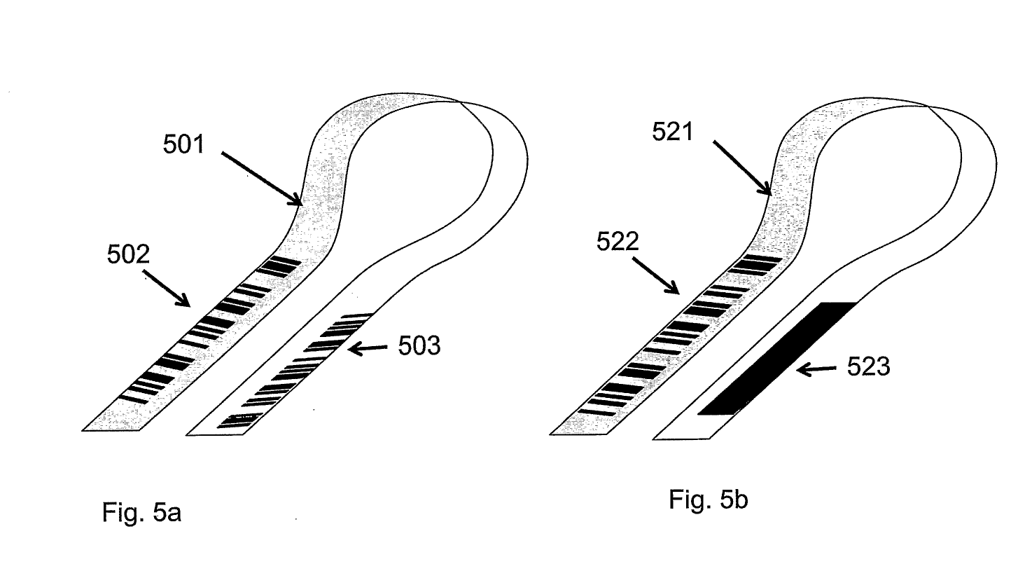

FIGS. 5a and 5b show additional preferred embodiments where a tag is arranged in the form of a strip that can be arranged into a loop.

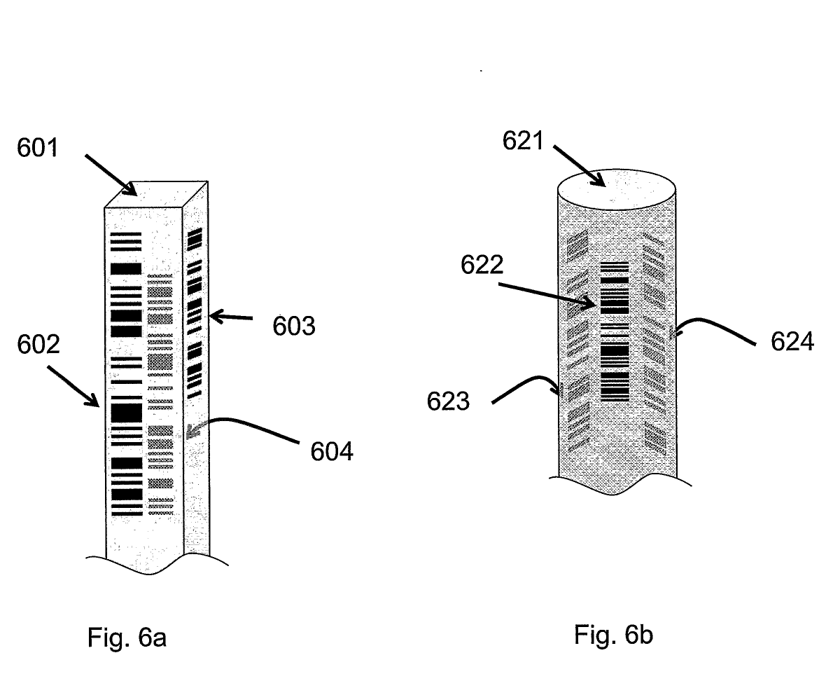

FIG. 6 shows embodiments where the tag is in the form of a bar or a rod.

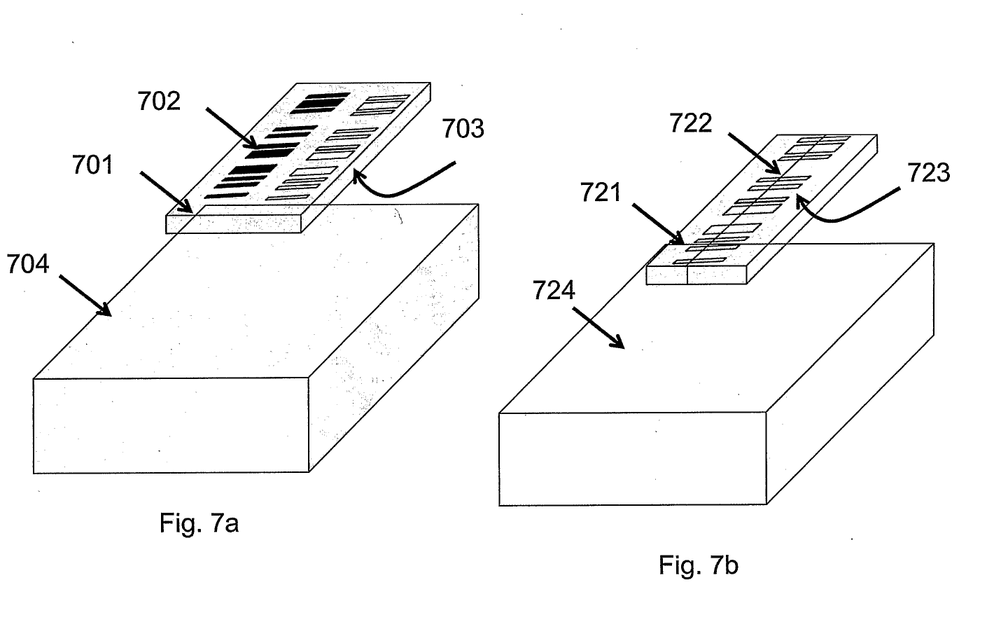

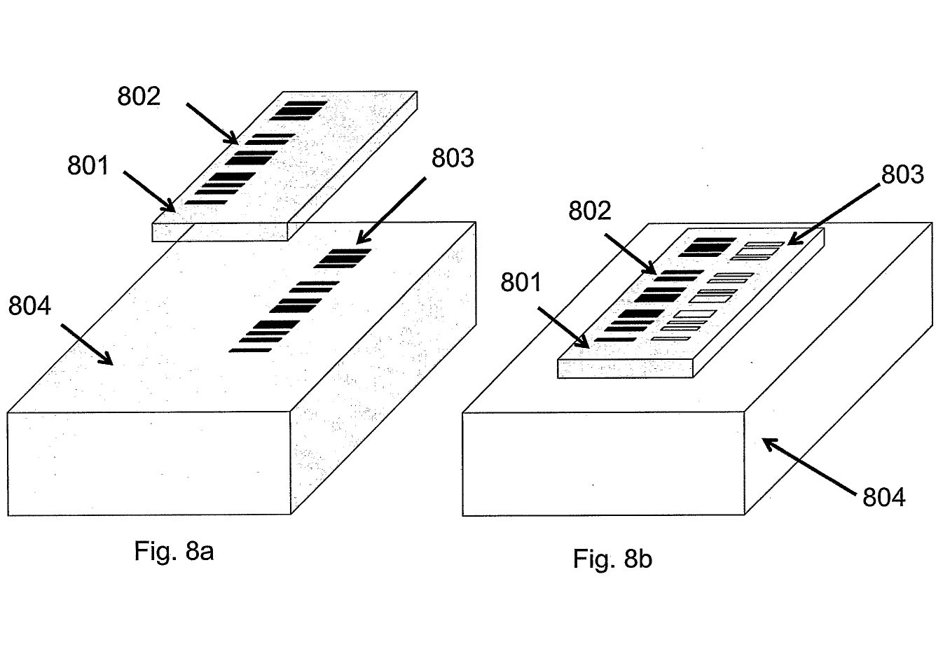

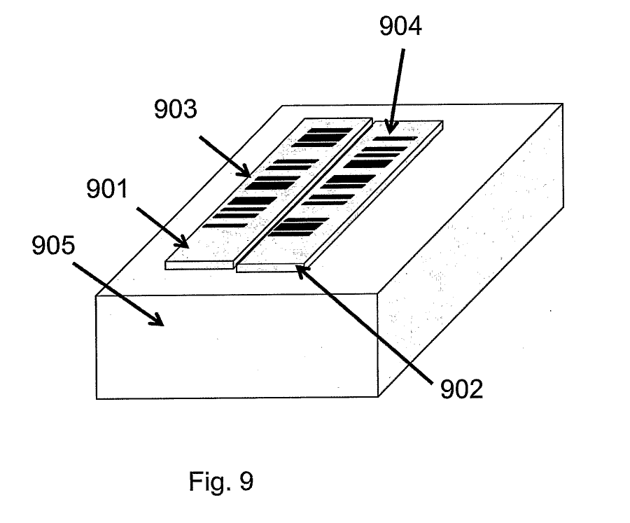

FIGS. 7 and 8 show tags where a set of identification information is arranged at the interface between the tag and the item of value.

FIG. 9 shows a tamper-proof tag arrangement that can be easily damaged upon being tampered with.

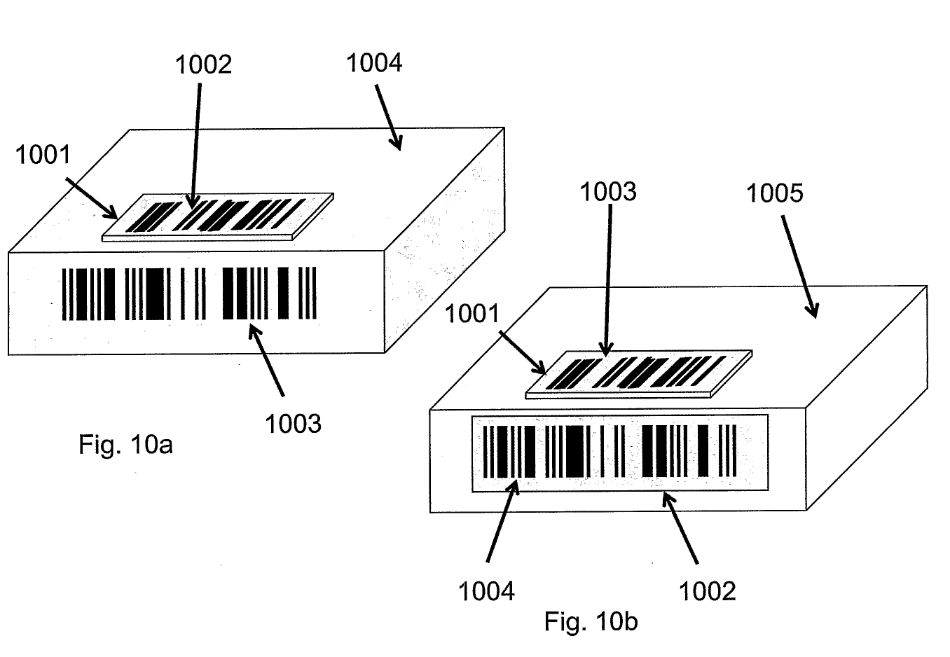

FIG. 10 shows an object where tags with identification information are arranged on different sides of an item of value.

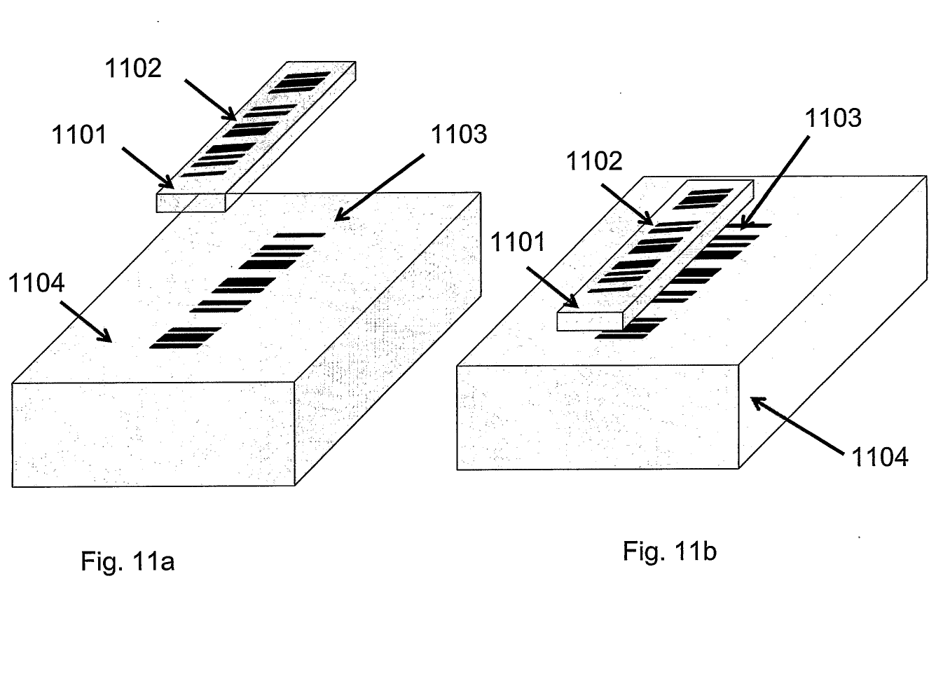

FIG. 11 shows an object with a set of identification information on the object and a printed tag containing another set of identification information.

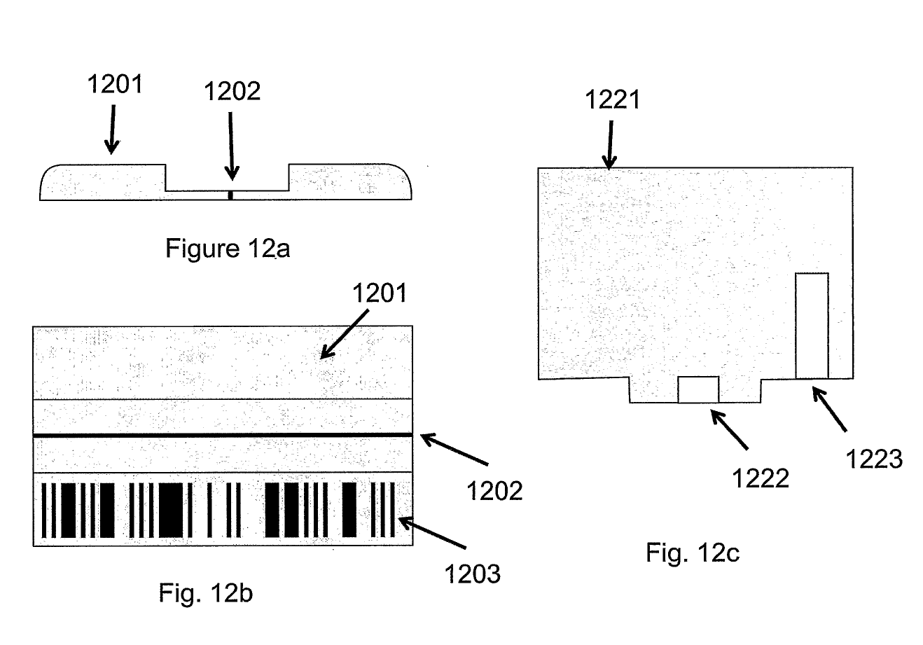

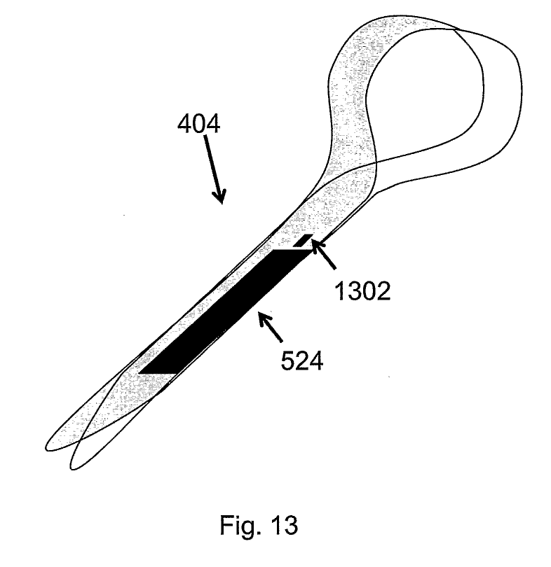

FIG. 12 shows an embodiment of the invention where the identification tag is non-planar.

FIG. 13 shows a loop tag in which an RFID tag is present as a set of identification information.

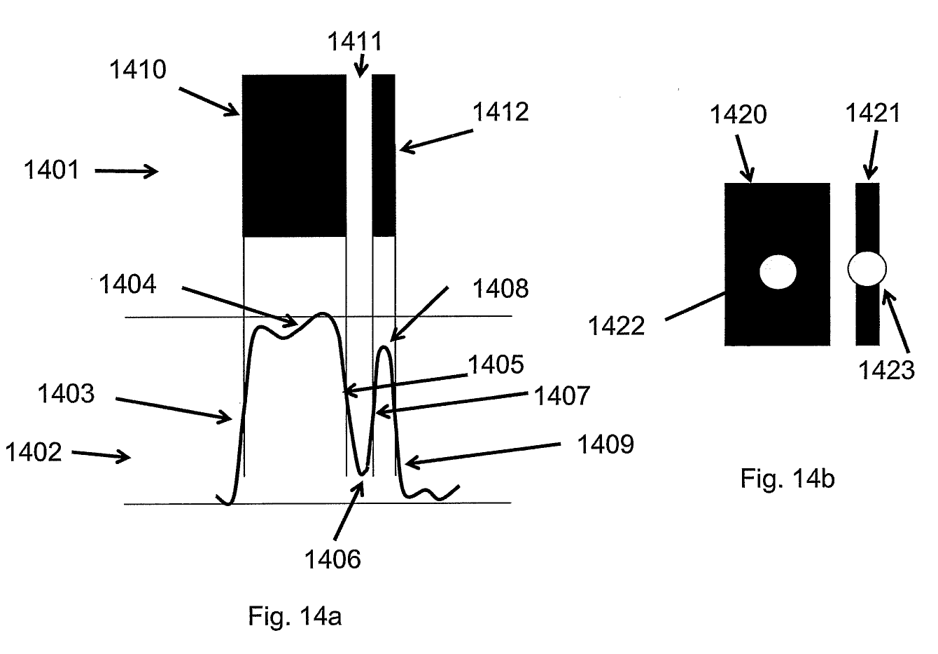

FIG. 14a shows the graphical representation of a reading of a portion of a 1D barcode; FIG. 14b depicts areas of a 1D barcode being interrogated by an optical sensor at two instances during the barcode reading.

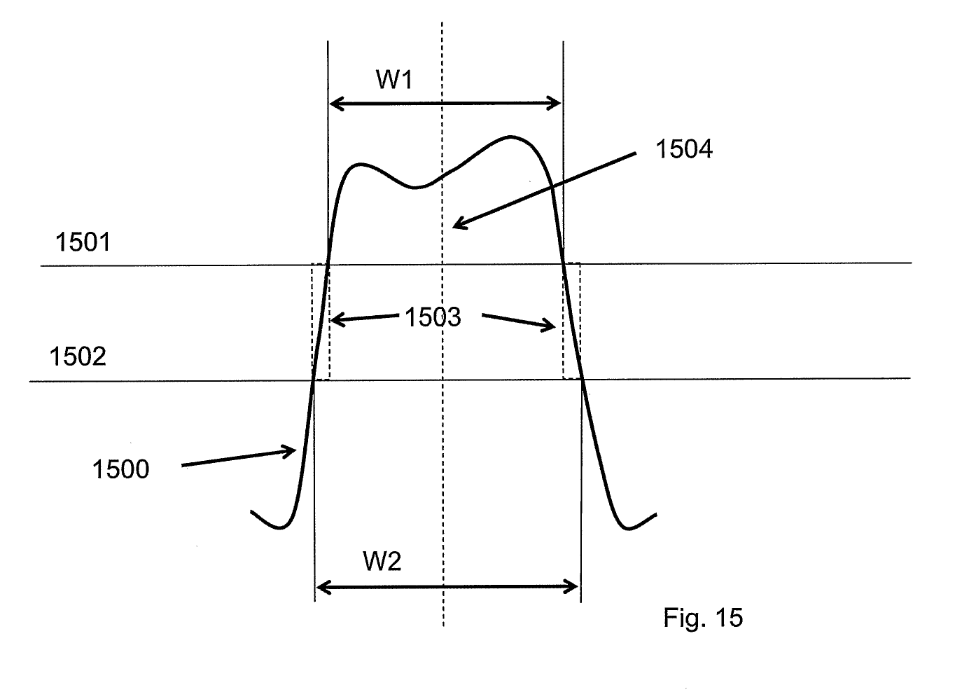

FIG. 15 shows a graphical representation of a portion of signal of a barcode reading in order to explain how analysis of the signal may be done.

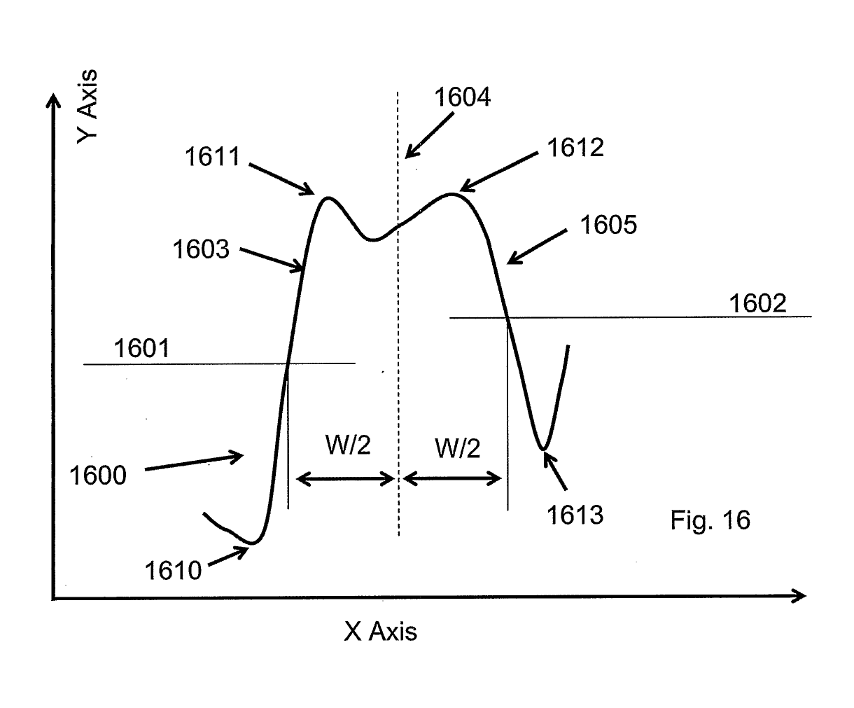

FIG. 16 shows a graphical representation of a portion of signal of a barcode reading in order to explain how analysis of the signal may be done.

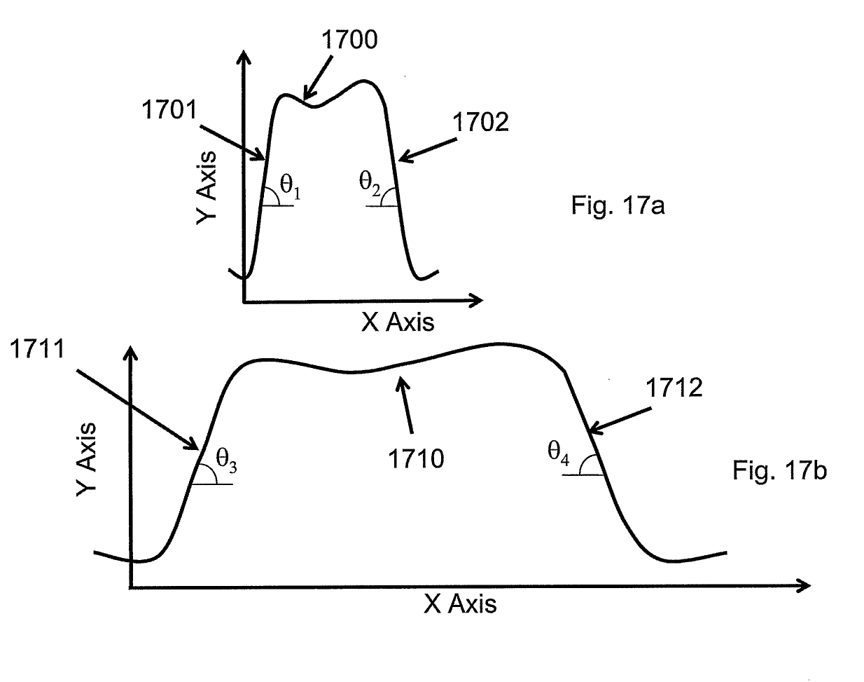

FIGS. 17a and b show a graphical representation of a portion of signal of a barcode reading in order to explain how analysis of the signal may be done.

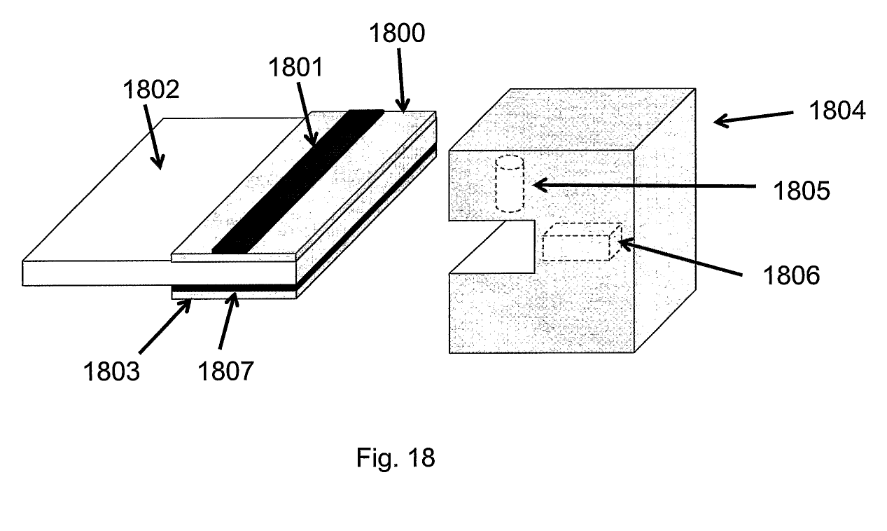

FIG. 18 illustrates an object that is tagged with two identification layers, one of which is readable via a main surface and another readable via its edge, and a reading device for reading the object.

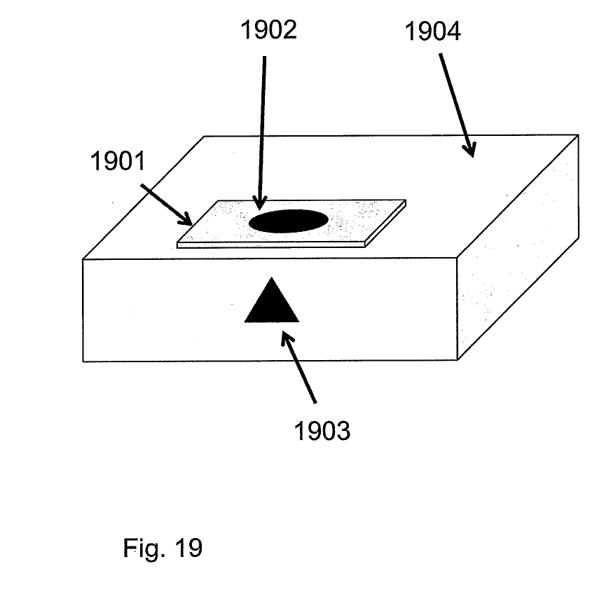

FIG. 19 depicts an object that is tagged with an elliptical area of identification information and a triangular area of identification information.

FIG. 20a shows an object having a first set of printed identification information arranged adjacent to a piece of rectangular-section material containing a further set of identification information; FIG. 20b shows a reading device for reading such an object.

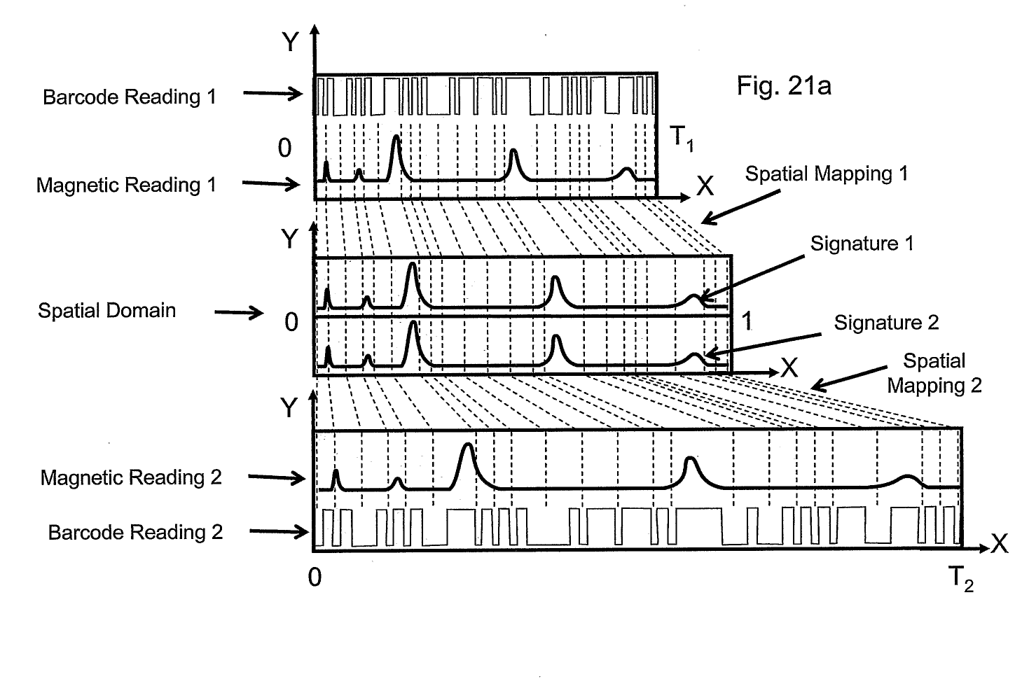

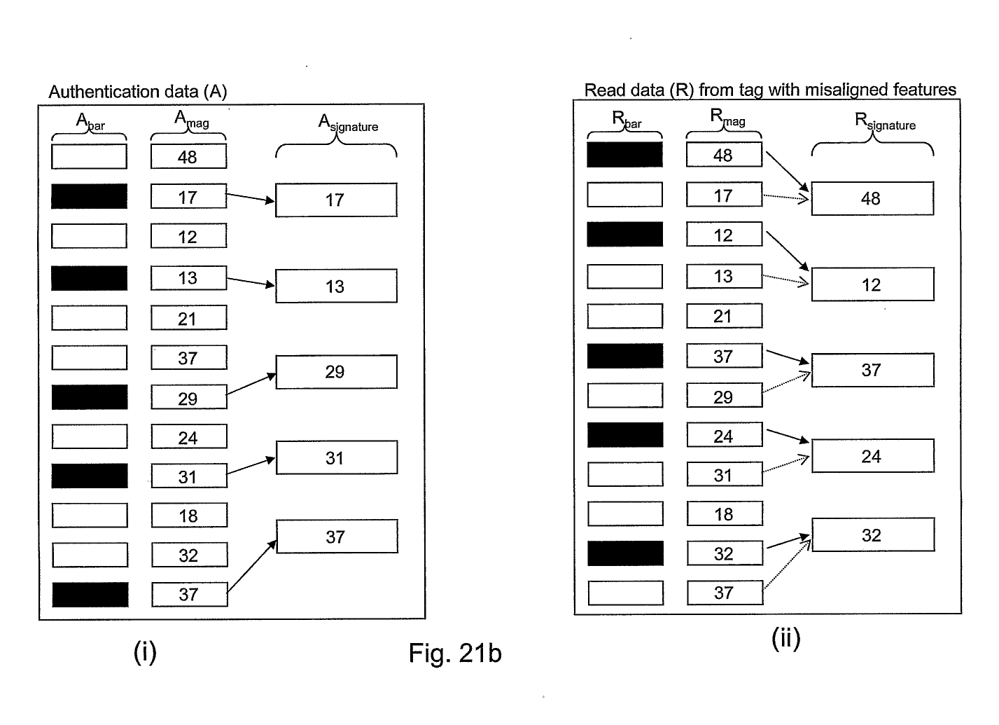

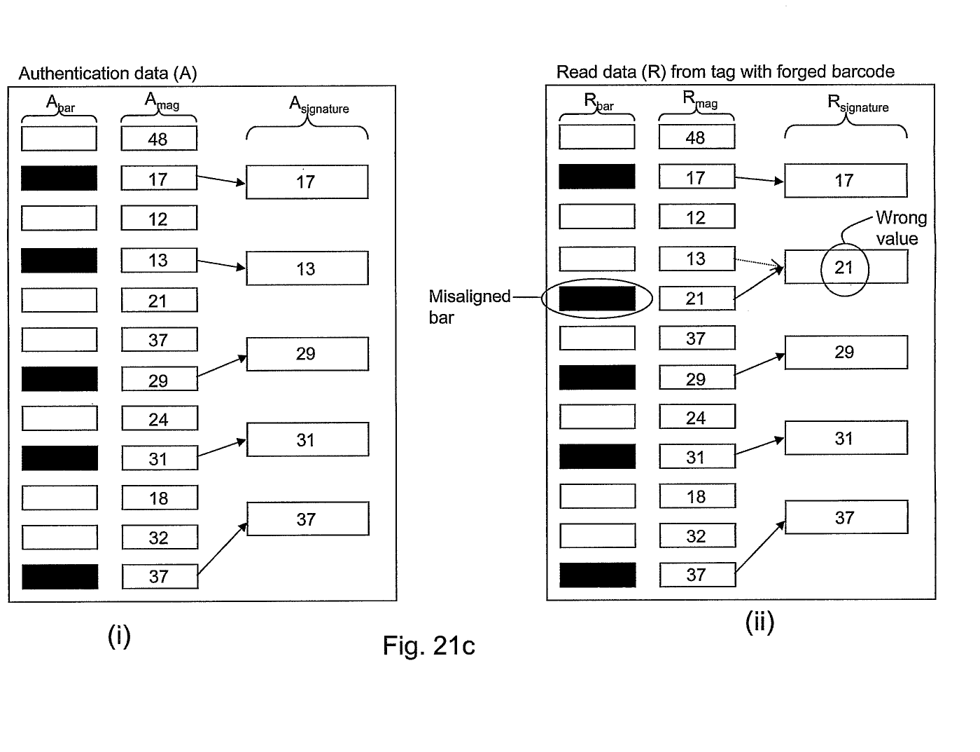

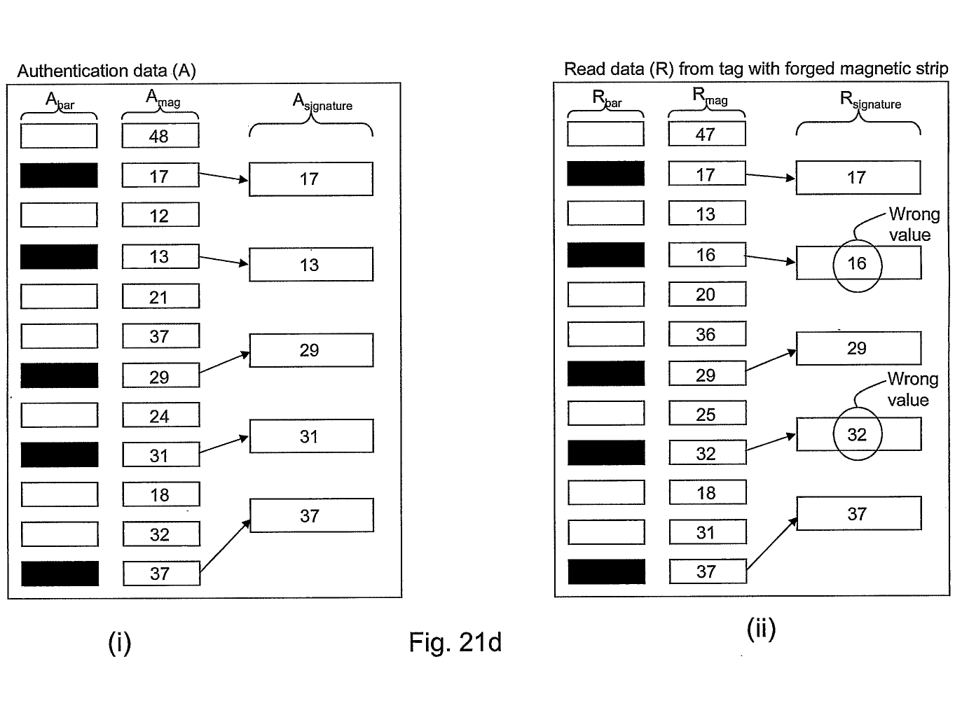

FIG. 21a depicts the normalization of time domain data from readings of separate sets of identification information into spatial domain data. FIGS. 21b to 21d depict various situations in which read signatures from tags with misalignments are mismatched against pre-stored reference signatures.

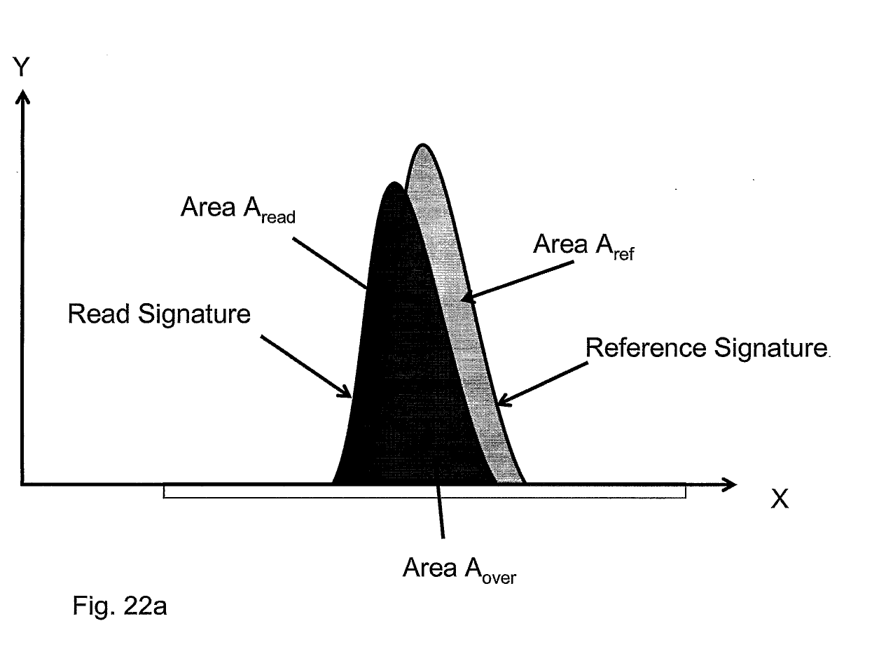

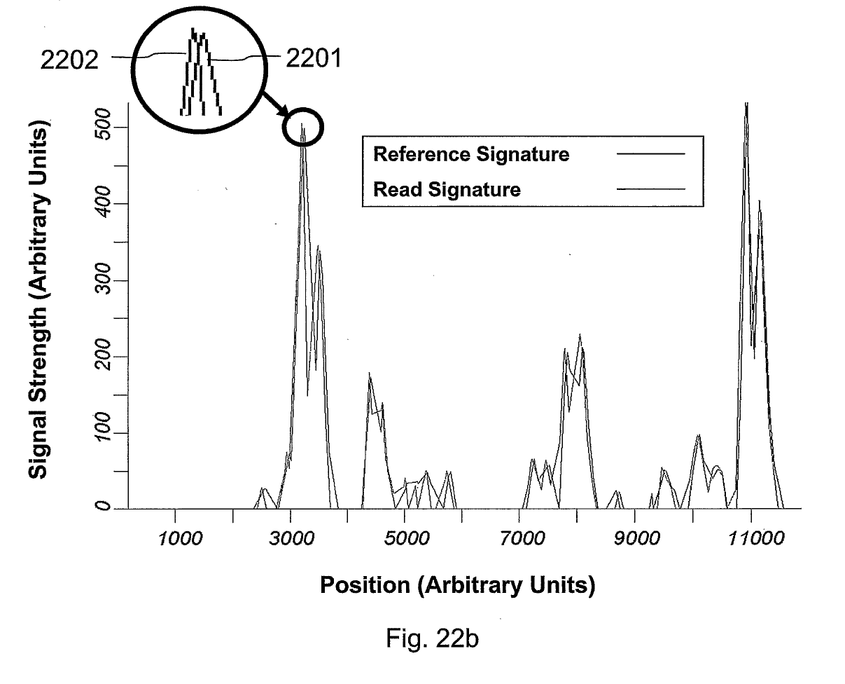

FIG. 22a and FIG. 22b show graphically how a read signature is matched against a pre-stored reference signature.

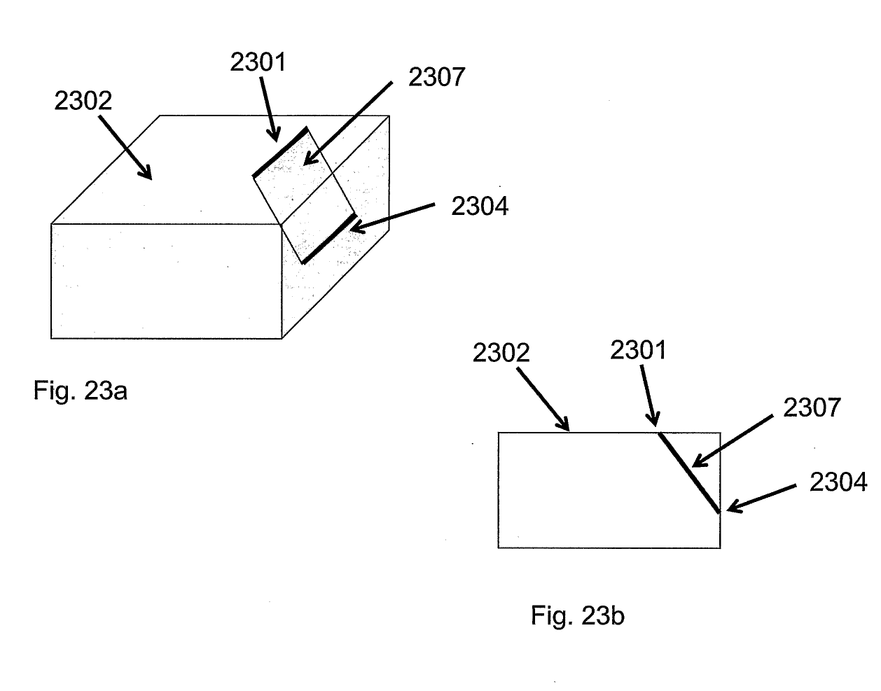

FIG. 23 shows an object having embedded in an oblique plane randomly distributed magnetic particles.

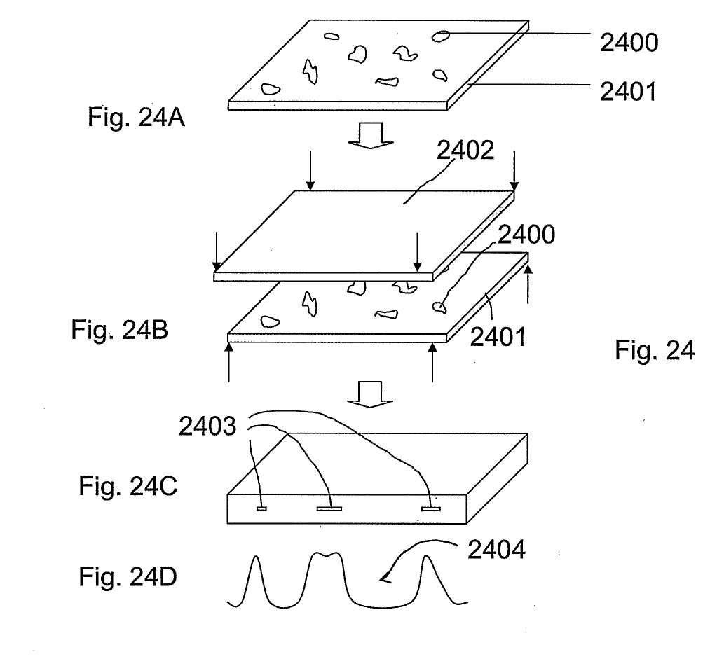

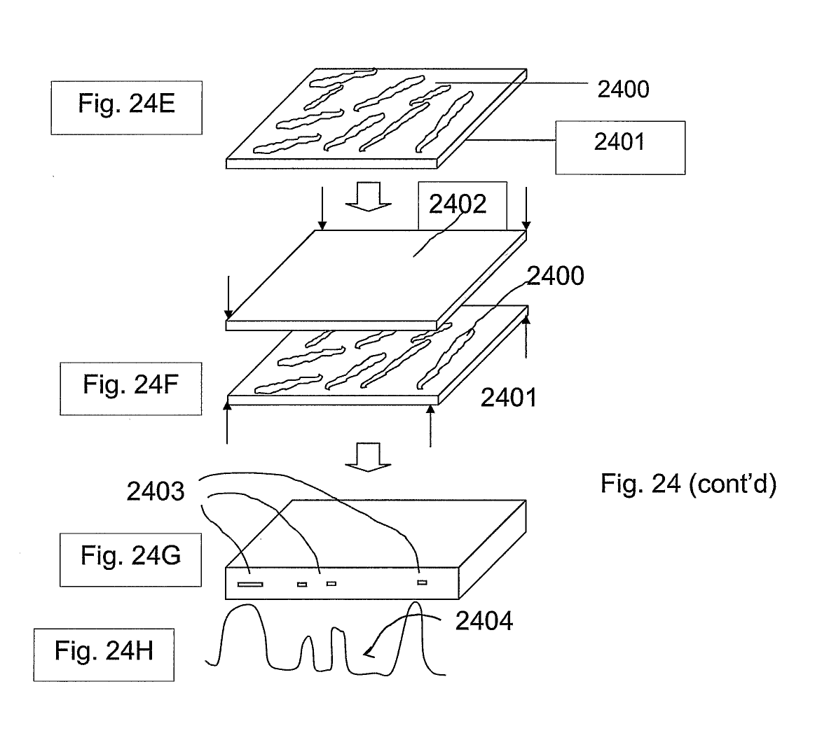

FIG. 24 shows a process for producing an identification layer using compact nickel flakes and using elongated nickel flakes.

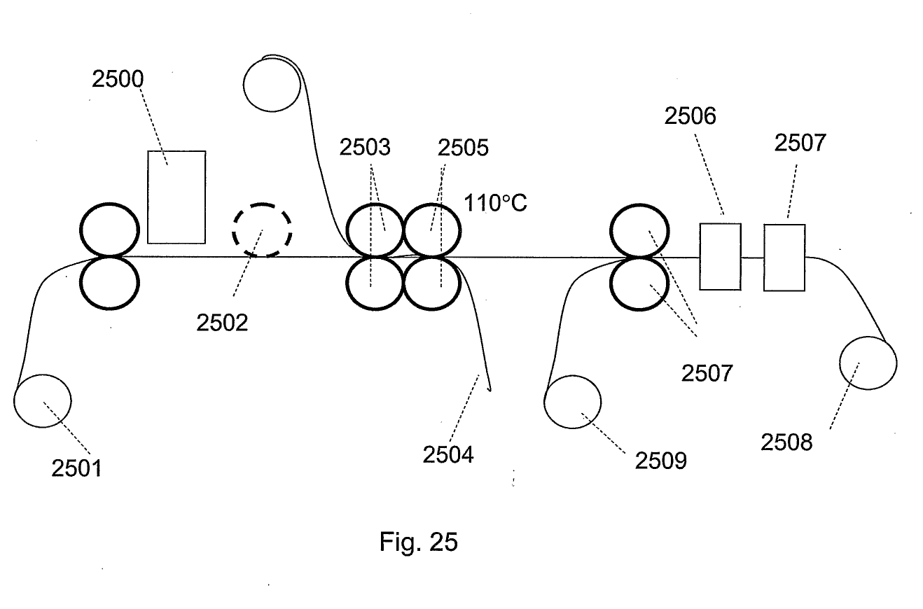

FIG. 25 shows a roll-to-roll process for manufacturing an identification layer.

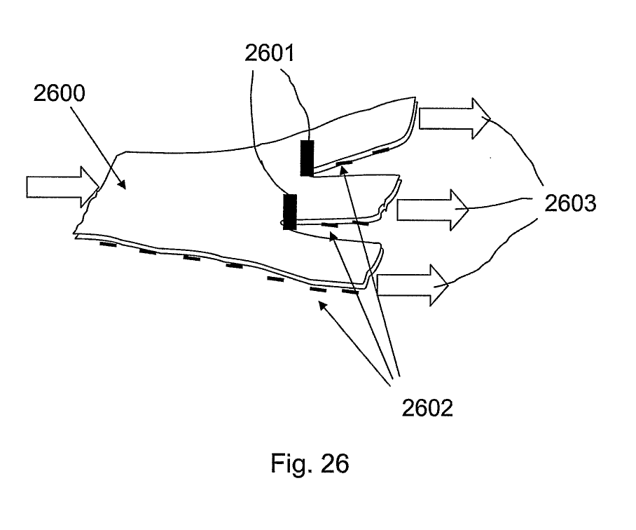

FIG. 26 shows an optional step for fabricating an identification layer.

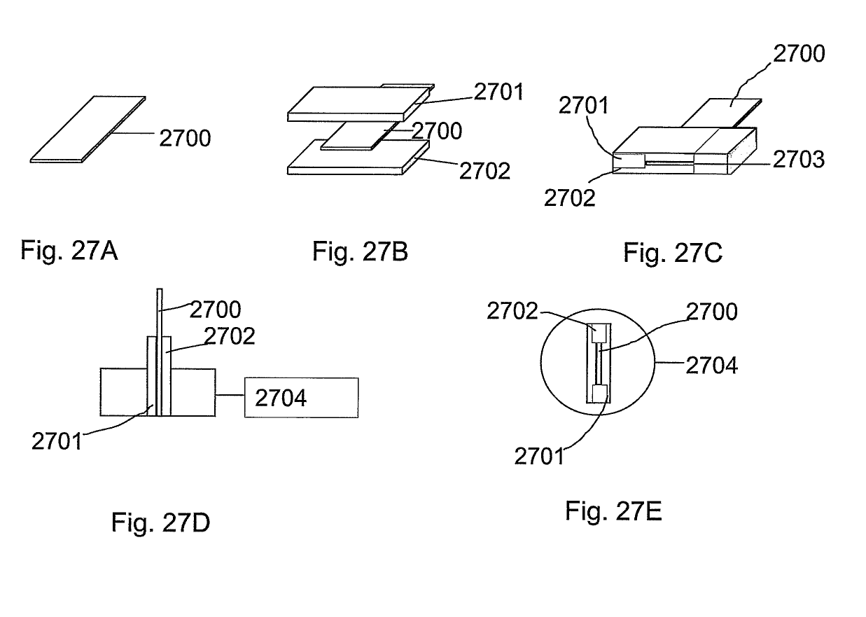

FIG. 27 depicts the preparation of fabrication of an identification layer using aluminum foil.

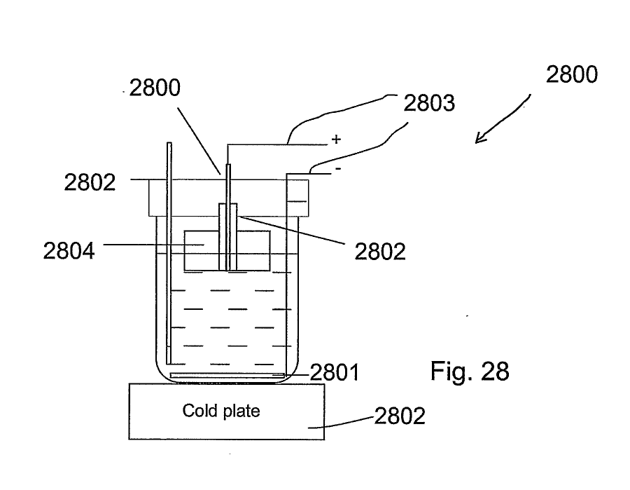

FIG. 28 depicts an anodizing process to form disordered host material in the aluminium foil.

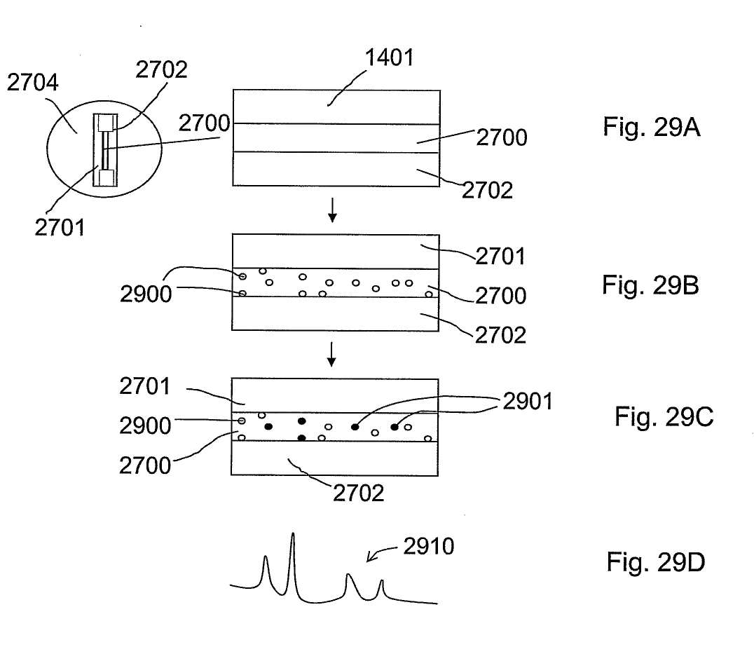

FIG. 29 shows the steps of pore forming and pore filling after anodizing the aluminium foil.

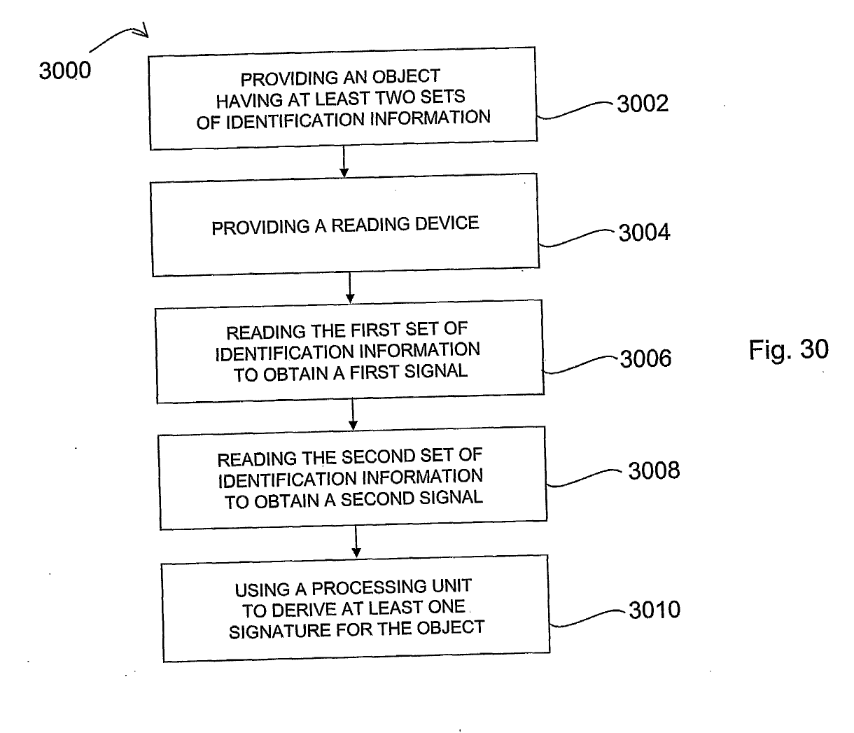

FIG. 30 shows a flowchart illustrating an embodiment of the method of identifying an object of the invention.

FIG. 1 shows an object (or a tag) according to one embodiment of the present invention. In FIG. 1a, an object that is adapted to be identified (which can also be understood as the identification tag itself) 100 has optical identification features 101 on its top surface 102. The object has further identification features, namely an identification layer, contained within a plane 103. These identification features may be magnetic features such as randomly distributed magnetic particles, or optically read features, for example optical fibers scattered in the plane. Any other consistently identifiable feature, such as physical undulations, may also be used. The relative spatial position between the features of the two sets of identification information is used to establish the signature for identifying the object. As can be seen from the figure, the identification information in plane 103 is readable along the edge of the object where the identification information is exposed.

FIG. 1b shows the reading of two sets of identification information on an identification tag 109 having, firstly, an identification layer 110 comprising magnetic features contained within a plane as described above, and secondly, a barcode symbol 130 that is arranged on a surface of the identification tag 109. The identification layer 110 is arranged between a top layer 112 and a bottom layer 111. The edge along which the identification layer 110 is being read can serve as a track for guiding the movement of a reading device along the identification layer when reading is being carried out. This track is defined by the edges formed by the top layer and the bottom layer and may be fitted into a slot of in a reading device when it is to be read. Alternatively, the track may also be formed by a groove defined between the top layer and the bottom layer, so that a reading element having a probe-like protrusion that fits into the groove can be used to probe and read the identification layer 110. Such a system provides immediate benefits in the production and reading of the track 113 namely: ease of manufacturing, ease of location and ease of reading through, for example, mechanical guidance.

The identification layer 110 comprises magnetic particles 121. When a reading element 108A is moved along the reading direction 122, a first read signal 123A representing the magnetic field strength of the magnetic particles 121 is detected. Likewise, when a reading element 108B is moved along the reading direction 122, a second read signal 123B representing the reflectivity of the barcode symbol 130 is detected. The track 113 exposes a portion of the identification layer 110 and allows the reading element 108A to access the identification information therein. The printed pattern is accessible from its main surface (as defined above) so does not necessarily require a track to guide the reading element 108B when reading is being carried out. However, if needed, the edge of the layer can also be used as a guide to ensure that the reading element 108B is moved correctly across the printed pattern.

In general, the signals obtained are readings of a physical property of the identification information. The readings may be of, for example, the variation in a magnetic field, reflectivity, an electromagnetic field, an electric field, electrical conductivity, electrical capacitance, electrical inductance, electromagnetic wavelength, electromagnetic wave amplitude, electromagnetic polarity, or a combination thereof. By correlating a first signal obtained from a first set of identification information to a second signal obtained from a second their features' spatial relationship, a signature can be established. Regardless of the physical property being measured, variations are generally determined along the longer dimension of the track, such that the sensor element of the detector extends, preferably, across at least the full width of this track. Additionally, readings of the identification features of a set of identification information may be carried out over a partial portion of the identification. For example, if the barcode is 2.4 cm in length, the discrete area on the identification information to be read by the reading device may comprise a section of about 1 cm of the leading section of the barcode or any other arbitrarily selected starting point, for example.

FIG. 1c shows an example of a reading device 104 that is adapted to read the identification information contained within both the surface 102 and plane 103 of an identification tag 100. The reading device consists of a slot 105 wide enough to allow the object 100 to slide through it. On the upper edge of the slot there is an optical reading element 106, which may for example be a barcode reading element. This optical element is positioned so as to read the optical identification features 101 as the object 100 slides through the slot 105. Similarly another reading element 107, on another edge of the slot, is positioned to read the identification features contained within plane 103. The identification features 101 and those contained within plane 103 are read simultaneously by either sliding the object 100 through the slot 105 or, conversely, by moving the reading device while holding the object still.

FIG. 2 shows graphically how data obtained from reading a first set of identification information, such as a barcode for example, can provide a frame of reference for mapping out specific values in a second or further set of identification information. In this example, the reading of a barcode may provide a signal 202 that can serve as timing markings for normalizing data in the time domain read from other identification features. Taking a magnetic identification layer as an example, the magnetic field strength signal 201 may be acquired by reading the variation in magnetic field strength read by reading element 107 as object 100 passes through slot 105. FIG. 2a shows how 2 separate signals can be combined to form a unique signature with which to identify an object. This is achievable, in particular, by plotting the relative positions of the magnetic peaks against the black/white transitions read simultaneously from the barcode. The peak 203 from the magnetic field strength signal 201 is located between two dark bars (herein depicted white) at about 100 micrometers from the left bar. This precise position can be easily determined under high resolution scans. It is the combination of these two signals, i.e. the magnetic signal correlated with the timing marks provided by the barcode that forms the object's signature. It is common for standard 1D barcodes to have black and white bars that are about 250 micrometers wide (e.g. a standard 2.4 cm long 12 digit UPC barcode). With some basic interpolation functions, such as the piece-wise linear interpolation function described in relation to FIG. 21, it is feasible to use the barcode identification features to map the position of the magnetic peaks up to a resolution of about one tenth of this distance or better, i.e. to within 25 micrometers depending on the resolution of the reading elements and device. This can be further improved using optical positioning systems such as are used in optical mice. Products being made by Advanced Optical Components, for example, have excellent resolution as fine as a few micrometers.

By identifying objects in this manner, even if a counterfeiter was able to accurately reproduce both the barcode and the magnetic identification layer, they would still have to accurately align the magnetic identification features with the barcode identification features. This is a difficult task. In this regard, it is noted that technology developed for the microelectronics industry such as backside aligners are capable of aligning photolithographic masks on the front and back sides of optically flat silicon wafers to accuracies of 1 micrometer or better. However, these systems are expensive and are not readily applicable for use with common barcode printing systems or alignment of magnetic particles for example. Consequently, it is difficult to deliberately copy and align identification features for the production of a counterfeit on different surfaces or planes of common plastic, paper or metal substrates, for example, to accuracies of 100 micrometers or better.

FIG. 2b shows the misalignment between the two sets of identification information if a counterfeiter were able to precisely duplicate both sets of alignment information but was not able to precisely align one set relative to the other. It will be seen that the peak 203 of the magnetic field strength signal 201 is shifted slightly to the right. Although this misalignment may be very slight (probably undetectable to the naked eye), it can be detected when read with a reading device and compared to the pre-stored reference signature. Depending on the required level of security to be applied on an object, accuracies of detection can be varied, varying from less than 50 μm for enforcing high levels of identification security to more than 200 μm for less costly items requiring lower levels of identification security. Higher accuracies can be achieved with reading equipment having high resolutions while lower accuracies can be achieved with relatively low resolution reading equipment. Therefore, by using a reading device and database (or memory device, memory chip, or other method of storing information) to store the object's pre-stored reference signature (said pre-stored reference signature being dependent on the identification features' spatial relationship) is a powerful tool to enhance anti-counterfeiting measures.

Although the invention has been described in the above examples in the context of using a magnetic identification layer and a barcode, other combinations are also possible. FIG. 3a shows a further embodiment of the invention in which two strips of material, 301 and 303, are printed with optical markings, such as barcodes, on them. They are then attached (using methods such as gluing or heat bonding, welding or stitching for example) to either side of an item of value 302 (for example a piece of fabric or metal). Once bonded together, the strips of material, including the item of value, form an object according to the invention. A reading device 304 adapted to read the object contains two optical reading elements 305 on either side of a slot. Even though easily reproducible 1D barcodes may be used as identification information on both strips of material, it would still be difficult to counterfeit or tamper with the object. While it may be feasible to print two barcodes that are identical to a large extent to the ones printed on each strip of material, or to move the barcodes from one object to another, the task of preserving the original alignment between the two sets of identification information relative to each other is difficult. In order to align them accurately, one would need to either first bond the strips to the item of value and then print the barcodes on them, or print the barcodes first and then bond them precisely to the item of value. The first option is difficult since: a) a specialized two side aligning printer would be needed, and perhaps more importantly, b) it would impractical to handle and feed items of value (e.g. metal objects and garments) into a specialized printing machine. In the second option, i.e. printing first and then attaching the strips to the item of value the difficulty comes from trying to accurately bond small strips onto an object.

FIG. 3b shows a similar embodiment to that shown in FIG. 3a. In FIG. 3b, the object includes optical identification features on the material strip 321 combined with a material strip 323 containing a plane 327 containing identification features, otherwise known herein as an identification layer. The reading device is shown having a reading element 326 that is adapted to read the identification features from the edge of the plane 327. To further enhance the tamper-proofing properties of such an object, the plane 327 could be strongly bonded to the item of value, but weakly bonded to the material strip 323—consequently if someone attempted to tamper with the object by replacing the item of value with a fake, the plane containing the identification features would be very difficult to transfer since it would stick to the original item of value instead of the material strip. It will be clear to anyone skilled in the art that various combinations can be used. For example, two strips each containing a plane of identification features could be bonded to the top and bottom of an item of value—an embodiment analogous to that shown in FIG. 3a.

FIG. 4 shows an identification tag according to an embodiment of the present invention. As shown in FIG. 4a, a strip of material 401 has two sets of identification features 402 and 403 on one surface. The strip is used to form a loop by bonding the ends of the strip together, as shown in FIG. 4b. By forming a loop, identification features 402 become arranged on a different surface from identification features 403. This bonded configuration now constitutes an object 404 as defined in the present invention—it has two sets of identification features which in this configuration are on different surfaces of the bonded unit. During the looping process, the material strip may be passed through or around an item (or a portion of an item) of value to form a loop that affixes the strip to the item. For example, the loop could be passed tightly around the nose bridge structure of a set of eye glasses (otherwise known as a pair of spectacles) for labelling purposes. In order to improve the security of such a tag, it is also preferable that the ends of the strip of material, 405 and 406, do not line up easily, thereby increasing the difficulty of aligning the two sets of identification information. In FIG. 4, the ends of the strip are shown as cut such that the ends taper in opposite directions so that it is difficult to line them up when the strip is bonded into its final configuration (FIG. 4b shows an example of the bonded configuration with the edges not lining up).

In order to tamper with the object as described above (for example replace the genuine eye glasses frames with a fake set), someone would need to either: a) Cut the loop of the material strip and rejoin it so that it was not noticed; or: b) they would need to de-bond the material from itself and loop it over the fake item and then re-bond it. Rejoining a cut strip would be difficult to do if for example the material strip 401 were made of thin plastic or some other material that was difficult to rejoin without creating a noticeable joining mark. It would be extremely difficult to do this precisely enough to adequately realign the identification features on either side of the object. This is made particularly difficult if the ends, 405 and 406, of the strip of material were cut as shown or in some other suitable fashion.

FIG. 5a shows a further embodiment of an identification tag. Here the strip of material 501 is shown prior to bonding to form an object. The strip is transparent and when it is bonded together both sets of identification information, 502 and 503, can be read from one side (i.e. the reading device does not need to have reading elements passing over both sides of the object). Furthermore, by printing the two sets of identification information on different sides of the strip, so that one of the printed regions lies at the interface where the two ends are joined, any tampering of the strip, e.g. the act of opening the strip, would destroy or at least alter the integrity of the markings so that they are not readable properly afterwards.

FIG. 5b shows yet another embodiment of an identification tag. The strip of material 521 is shown prior to bonding to form an object. The strip has an optical marking 522 on its top surface and a non-magnetic binder containing randomly distributed magnetic particles 523 on the other surface. Once bonded together the object can be read using a reading device containing an optical reading element and a magnetic reading element.

FIG. 6a shows a further embodiment of an identification tag. Here, an identification tag 601 with a square cross-section (hereinafter known as a “bar tag”) has optical markings 602, 603 and 604, on three surfaces. The tag is attached or embedded into an item of value using any suitable means (not shown), such as gluing, soldering or embedding its base into an item as it is molded. The tag can be read using a reading device having three optical reading elements positioned around a square slot, for example. Alternatively, if the tag is transparent, a reading element may be used to read the optical markings from two opposing surfaces. One method to easily manufacture such a tag would be to affix barcode stickers to the sides of a square cross-sectioned article.

FIG. 6b shows a further embodiment of the present invention. Here an identification tag 621 with a circular cross-section (hereinafter known as a “rod tag”) has optical markings 602, 603 and 604, on three sides of the same surface. The tag is attached or embedded into an item of value using any suitable means, such as heat bonding (not shown). The tag can be read using a reading device having three optical reading elements positioned around a circular slot, for example. One method to easily manufacture such a tag would be to affix barcode stickers to the sides of a circular cross-sectioned article. From the preceding figures, it is apparent that identification features contained within any number (more than one) of sides, surfaces or planes could be used could be used in combination to form an object under the present invention. Furthermore it is apparent that virtually any shaped object is suitable, triangular, “T” or “H” cross-section objects, for example, are difficult for counterfeiters to align identification features on.

FIG. 7a shows all object (or tag) 701 prior to being bonded to an item of value 704. The object is made from transparent material and has optical identification information, 702 and 703 on it top and bottom surfaces respectively. Since the object is made from transparent material, both the sets of optical identification information on the top surface and those on the bottom surface can be read while the object is attached to the item of value. The optical identification information 703 on the bottom surface may be designed in such a way that if the object is removed from the item of value at least some of its identification features remain adhered to the item of value instead of peeling away with the rest of the object (or alternatively becomes impossible to read). This is similar to how many existing tamper-proof labels operate, and methods for achieving this effect are well-known in the art.

FIG. 7b shows a similar object (or tag) to that shown in FIG. 7a. In this case, the object 721 comprises identification features 722 in a plane combined with identification features 723 on a surface. Again the object is shown prior to being bonded to an item of value 724.

FIG. 8a shows one set of identification features 802 arranged on a strip of transparent material 801 while the second set 803 arranged on the item of value itself 804. Prior to bonding, no “object” in accordance with the invention exists even though the components of such an object are present, i.e. two sets of identification features 802 and 803 on different surfaces, sides or planes. Only once all the components shown in FIG. 8a are bonded together, the bonded components then form an object according to the present invention. Here, the item of value forms part of the object of the invention. For tamper proofing purposes, it is preferred to have the identification features 803 bonded to the item of value so that they remain at least partially attached to the item of value 804 if the strip 801 is forcibly detached from the item of value. It will be apparent to anyone skilled in the art that in the above example, 804 need not be the item of value, but may instead be another part of a composite object that is to be attached to the item of value.

FIG. 9 shows a further embodiment of the present invention. Here two separate strips of material 901 and 902, each with their own sets of identification features 903 and 904 respectively are bonded to an item of value 905. The bonded unit forms an object according to the present invention since two sets of identification features, 903 and 904, exist on different (for example physically) surfaces but are part of one unit, i.e. the object.

FIG. 10a shows another embodiment of the present invention. This is similar to the embodiment shown in FIG. 8. A set of identification information 1002 are printed on a strip of material 1001. However, a second set of identification information 1003 is arranged on a surface of the item of value 1004, namely, on a surface lying orthogonally to the top surface of the strip of material. In this example, the each set of identification information is located on a different surface.

FIG. 10b shows another embodiment of the present invention. This is similar to the embodiment shown in FIG. 9. Two separate strips of material 1001 and 1002, each with their own sets of identification features 1003 and 1004 respectively, are each bonded on a surface of an item of value 1005. The bonded unit forms an object according to the present invention since two sets of identification features, 1003 and 1004, exist on different surfaces but are part of one unit, i.e. the object. Unlike FIG. 9, the identification features in FIG. 10b lie in planes that are perpendicular to each other.

FIG. 11 shows another embodiment of the present invention. This is similar to the embodiment shown in FIG. 8. FIG. 11a shows components prior to being bonded together. Again, prior to bonding, no “object” exists according to the present invention even though the constituents of an object are present, i.e. two sets of identification features 1102 and 1103 on different surfaces, sides or planes. One set of identification features 1102 is on a strip of material 1101 while the second set 1103 is on the item of value itself 1104. FIG. 11b shows the situation once all the components shown in FIG. 11a are bonded together. The bonded components now form an object according to the present invention. Again the item of value now forms part of the object. Unlike the case shown in FIG. 8, here the strip of material 1101 need not be transparent.

FIG. 12 shows another embodiment of the present invention. FIG. 12a shows a cross-sectional view of an object 1201 according to the present invention. The object has a plane of identification features 1202 embedded in it. FIG. 12b shows the object 1201 in plan view. A further set of identification features 1203 can be seen on one surface of the object. FIG. 12c shows a reading device 1221 that has been adapted to read the object. The reading device is shaped so that its two reading elements, 1222 and 1223 align to read the identification features 1202 and 1203 respectively.

FIG. 13 shows another embodiment of the present invention in which an RFID chip 1302 (which can be an active or a passive RFID chip) is used as one of the means of identification in conjunction with another means of identification (such as the magnetic material, 524), in this case using the example format 404. The RFID chip can provide reference markings or timing marks. For example, when an RFID tag transmits regular RF waves which can function as coordinates for mapping the identification information 524. For example, the intensity profile of the RF signal can then be recorded with position and used to provide a signal with which to correlate the other information.

This embodiment may be put into practice by having a small antenna (either separately attached to the RFID chip, and on one plane of the object formed, or as an on-chip antenna), that provides only enough signal to be reduced to at or near zero at the farthest point of the object from the RFID chip. One scheme is that as the reader passes over or near the RFID chip, it will trigger the RFID chip to send the identification information, and then it sends a series of on/offs, a square waveform or a sinusoidal waveform that as the reader moves away from the reader and along the other identification material, the attenuation of the signal can be measured and used as a continuous positioning sensor. This can be related to a peak (as the RFID reader passed overhead of the RFID chip) or the end-point, when the signal becomes undetectable or below a determined threshold value.

FIG. 14a depicts a section 1401 of a standard 1D barcode. The section consists of a broad black bar 1410, a narrow white bar 1411 and a narrow black bar 1412. Below the section of the barcode, a typical corresponding analogue signal 1402 obtained from a barcode sensor used in a pen-type barcode reader (an example of such a sensor is an Agilent HBCS-1100 optical sensor) is shown. In the case of an Agilent HBCS-1100 optical sensor, a higher output signal corresponds to a lower sensed reflectivity, hence in the example discussed here black bars are shown as signal maxima where as white bars correspond to minima. However, obviously different sensors provide different signals based on the reflectivity measured so whether a black region corresponds to a maximum or a minimum is irrelevant to the invention. The signal consists of a rising signal intensity 1403 as the sensor reads the change from the white area to the black bar 1410. Thereafter, the signal plateaus 1404 as the sensor reads the black reflection from the black bar 1410. Then, the signal decreases at slope 1405 as the sensor reads the transition from the black bar 1410 to the white bar 1411. The signal then reaches a minimum 1406 corresponding to the white bar 1411. Thereafter, the signal again increases along slope 1407 as the sensor starts to sense the next black bar 1412. It then reaches a maximum 1408 corresponding to the maximum signal read from the black bar 1412. Thereafter, the signal decreases along slope 1409 again as it senses the transition back to a white area after the black bar 1412.

As can be seen from FIG. 14a, the maxima (1404 and 1408) do not show the same intensity. Similarly, the minima (1406 and the minima shown at the beginning and end of the signal segment) are also not of the same intensities. This is a typical situation if the resolution of the barcode sensor is not fine enough to completely resolve the smallest bars in the barcode. As shown schematically in FIG. 14b, the figure depicts a section of a barcode—the section consisting of a broad black bar 1420, a narrow black bar 1421 and the white area in between the bars. The sensor senses the barcode reflectivity over a circular region. The circular region 1422 shows a region sensed by the sensor as it passes over the broad black bar. The circular region 1423 shows a region sensed by the sensor as it passes over the narrow black bar. As can be seen from the figure, while the sensor passes over the broad black bar the region sensed by the sensor is completely black, whereas when the sensor passes over the narrow black bar its sensing region is never completely black, there will always be some white within the area that is sensed. This means that the maximum signal when the sensor travels over the broad black bar will be greater than the maximum signal when it travels over the narrow black bar. This is also true for the signal minima for different width white areas. This kind of situation also occurs if the sensor has sufficient resolution but is not properly focused on the barcode, or if the number of data points obtained is not sufficient to fully resolve the narrowest bars in the barcode. For example, if only a few data points are obtained for the narrow bars it is likely that the maximum will not be properly recorded since the data points obtained may not correspond to when the sensor is fully aligned to the black area. This may occur if the scanning speed is high or the data acquisition speed is relatively slow. The intensities of the maxima and minima can also be affected by fading or discolouration of the barcode, other forms of damage such as smudging, scratching or physical issues such as misalignment between the barcode sensor and the barcode. The noise in the signal obtained can also be affected by these conditions. Although the situation is described here for 1D barcodes it also occurs in various forms for other identification features, including for example 2D barcodes and character codes.

Since the invention relies on accurate position sensing between two different sets of identification features, it is usually ensured that the positions of the identification features are accurately determined. Using the 1D barcode example, the inventors have found that either the centres of the transition points between the black and the white areas, or the middle points of the black and white bars can be accurately determined and be used as positional reference points. Any suitable mathematical method can be used for this purpose. FIG. 15 shows how the positions of a bar may be determined from its reflectivity signal. The figure shows a portion of a sensed signal 1500 corresponding to sensing a black bar. A simple way to obtain the centres of the transitions between the black and white bars would be to determine the average of the signal and then find where each transition crosses this average value. However, this method was found to be fairly inaccurate since it is highly sensitive to the average value chosen. For example, if the average is too high 1501 then, in the example shown in FIG. 15, the black bars would appear too narrow (the measured width of the black bar would be W1 as shown in the figure) and the white bars too wide. Conversely, if the average is too low, the white bars appear too narrow while the black bars appear too wide (the measured width of the black bar would be W2 as shown in the figure). The error between the two measurements is depicted by the grey shaded regions 1503—this highlights that unless the correct average is found, the error may be significant. Finding the correct average can be difficult since the barcode may be discoloured along its length effectively leading to a varying average across its length. Furthermore, the average may be difficult to determine since it is not necessarily the average of all the data read (if it were it would imply that exactly equal areas of black and white were read and their reflectivity was uniform across the entire length of the barcode).

However, it has been found that in the context of this invention, measuring the middle points of the black and white bars is less sensitive to the average value chosen. Again using the averages 1501 and 1502 shown in FIG. 15, the middle point is found by measuring the mid point of the measured widths W1 and W2, which in both case gives the centre of the black bar, 1504. This demonstrates that if an average line is used for measurements, it is more reliable in some embodiments to use the mid point of the bars (both black and white) as the relevant position to compare with the positions of the other identification features sensed.

FIG. 16 shows a portion of a sensor signal 1600 as it senses a black bar. In the figure, the angles of the slopes of the white to black transition 1603 and the black to white transition 1605 are not equal (this will occur if, for example the white along slope 1605 of the bar is not quite as reflective as that on the 1603 side of the bar, e.g. some smudging or localized discoloration has occurred). One way to obtain an accurate middle point for the black bar in this situation is described below. The minimum point 1610 and maximum point 1611 of the slope 1603, and the minimum point 1613 and maximum point 1612 of the slope 1605 are found. The average intensity (in the figure this is plotted on the Y axis) for the slope 1603 is given by the average intensity (i.e. Y axis value) of points 1610 and 1611. Similarly, the average intensity of the slope 1605 is given by the average intensity of the points 1612 and 1613. Based on these calculations, the average value of 1603 is shown schematically as line 1601 and the average value of 1605 is shown by the line 1602. The X-axis values of the midpoints of the slopes 1603 and 1605 are then given by the intersection of the slope 1603 with line 1601 and of 1605 with 1602. The middle point (on the X axis) of the black bar (represented by 1604) is then given by the point halfway between the mid points of the two slopes.

Once the reference points of one set of identification features have been determined, they can then be used to plot the relative position of the other set or sets of identification features (as shown in FIG. 2) i.e. they can be used to normalize the data obtained from the other sets of identification features.

It has been found to be advantageous to measure the data from the sets of identification features simultaneously, because the positions of the identification features need to be compared to each other and this can be achieved by programming the same microprocessor to obtain the data from readings of each set of identification information simultaneously. For example, the microprocessor within the reader can read one point from the barcode sensor then one point from another sensor (e.g. a sensor measuring the strength of the magnetic field from a set of identification features); it would then repeat this process until all the useful data had been collected. In this manner, the data received from the different sets of identification features are easy to compare and normalize with respect to each other since the time between data points obtained from the various sensors is accurately correlated. For example, if a reader that is obtaining data from a 1D barcode uses this approach in order to normalize data obtained from a random set of magnetic particles, and at least ten data points are sampled for each black or white bar of the barcode, then at least ten corresponding data points of the magnetic signal are obtained simultaneously too. This means that the position of the magnetic data points is known with respect to the positions of the bars in the barcode to an accuracy of about 1/10^{th} of the width of each black and white bar (assuming that the reader passes over each bar with a uniform velocity). Therefore, assuming that the average size of a black bar in a barcode is about 500 μm, the accuracy of the magnetic data position can be in the region of about ±50 μm (assuming the reader passes over the object with a uniform velocity).

FIG. 17a shows a portion of a read signal 1700 as the sensor senses a black bar. FIG. 17b shows the corresponding portion of a read signal 1710 as the sensor senses the same black bar, but where the relative motion between the barcode and the sensor is slower (e.g. the sensor is moved over the barcode more slowly). As can be seen from the figure, the signals 1700 and 1710 are the same except that 1710 is more “stretched” in the X axis direction (here the Y axis represents the intensity of the signal recorded by the sensor and the X axis represents time). Since the sensor is being moved more slowly, the time taken to move across the bar is obviously longer. If the sensor is moved by hand over the barcode then there will be variations in the speed with which the sensor is moved between different readings and also within the same barcode reading (i.e. the sensor will not be moved at perfectly uniform speed over the barcode). If the microprocessor within the reader is acquiring data at a uniform rate (i.e. a uniform time between data readings), then relatively few data points will be acquired for 1700 as compared with 1710.

In extreme cases, this may mean that too few data points are acquired to adequately resolve the bar in the case of 1700, whereas in the case of 1710, so many data points may be acquired that the memory of the microprocessor is completely used before the end of the barcode is read (i.e. the memory “overflows”). One method of preventing this is to use the slopes of the transition between white and black (1701 and 1711) and between black and white (1702 and 1712) in order to estimate the velocity of the relative motion between the reader and the barcode. Since the slopes of these transitions are relatively uniform in most cases where the velocity is the same, the gradient of these slopes can be used to estimate the speed that the reader is travelling with respect to the barcode at that point. If for example a steep slope is measured (such as 1701 and 1702) then the rate that the microprocessor is reading data at should be high (in order to sample enough data points). Whereas if the slopes are shallow (such as 1711 and 1712) then the data sampling rate should be lower (in order to prevent memory overflow). Since the speed of the reader over the barcode is not uniform when the reading is done by hand the microprocessor can be programmed to dynamically adjust its sampling rate according to reading speed (calculated from the gradient of the slope) each time that a slope is recognized. This allows an appropriate data sampling rate to be used at all points along the barcode. So long as the sampling rate or time of each reading is stored this allows the data to be represented in the time domain, if necessary.

In carrying out the reading of two different types of identification information, it is important to ensure that the positions of the identification features be compared or normalized with each other (not necessarily the times when each datum was measured unless it can be related to a position). If one set of identification features consists of a known quantity (e.g. a barcode where the slope of the transition between black and white is a fairly uniform identification feature) and the other set or sets of identification information are unknown quantities (e.g. the signal obtained from randomly dispersed magnetic particles of various sizes and shapes where it is very difficult or impossible to predict any identification features that should be uniform), then the rate of the data sampling for both the known and unknown identification features could be determined by the rate determined to be optimum for the known identification features. In other words, the sampling rate used for the barcode sampling could also be used to sample the magnetic information from the other sensor assuming that it moves at the same relative speed to the magnetic data as the barcode sensor moves with respect to the barcode, and that the resolution needed to resolve the magnetic data is similar to that of the barcode data. If the resolution needed is higher or lower than the barcode data then a proportionately higher or lower sampling rate could be used (e.g. a factor of 2 times whatever the barcode sampling rate is determined to be at that point).

In the above paragraph relating to FIG. 17, it is described how the slopes of the transitions 1701, 1702, 1711 and 1712 can be used to estimate the scanning speed during the actual scan. It was assumed that the gradients of the slopes should be relatively uniform if the scanning speed is constant. However, in relation to FIG. 16, it was shown that the slope can be affected by discoloration etc. of the bars. Consequently, the inventors have found that it is more accurate to calculate the scanning speed using the number of data points acquired over the length of the transition. For example, using a data acquisition speed of X data points per second, if P points were acquired during the 1603 transition (i.e. from the bottom of the slope to the top of the slope), then the transition took P/X seconds. If the reader is still moving at this same speed (relative to the barcode) when it reaches the 1605 transition, then even though the transition is to a discoloured bar (i.e. of a different slope), it is expected that the number of points acquired during the transition to be P. This is because the transition begins when the sensor begins to sense the new bar and ends when the sensor has fully sensed the new bar (i.e. when it no longer sees any of the old bar), i.e. the beginning and end points of the transition are physical phenomena relating to the width of the sensed area and are not as sensitive to the actual colour of the bars themselves. By calculating the number of data points acquired during the transitions, it was possible to obtain even more accurate estimates than by using the gradients of the slopes of the transitions.

Although the foregoing discussion has dealt with optical patterns in the form of 1D barcodes, they have been purely chosen for the ease of explanation. It will be appreciated by the skilled person that methods similar to the ones explained can be used regardless of what type of identification features are being read. For example, it would apply to optical character recognition, lengths of 2D barcodes, and portions of fixed interval timing marks (where these marks may be optical, magnetic or textural, for example).

If a barcode is used to identify reference position points to normalize a signal from a second set of identification features, then a misreading of the barcode could potentially mean that it is difficult to properly match and identify the read signature with its pre-stored reference signature that is stored in the database (or other data storage medium). In order to address this problem, error handling provisions will be considered in the following paragraph.

One provision for error handling involves allowing a user to separately key in (type-in or enter) the barcode number. Alternatively, another device may be used to separately read the barcode and to send the read information for reconciliation, e.g. a scanning laser reader that reads a greater portion of the barcode from a distance and may not be susceptible to small defects in the barcode). Provided that a significant portion of the barcode has been read correctly, it is often possible to regenerate the barcode transition points and middle points of the black and white bars in order to regenerate the positional data needed to normalize the read signature in order to compare it with the relevant pre-stored reference signature. Additionally, 1D Universal Product Code (“UPC”) type barcodes, for example, have three sets of timing marks, these consist of two narrow black bars separated by a narrow white bar. There is one set of such timing marks in the beginning of the barcode, one in the centre and one at the end. Furthermore, digits in the barcode consist of known combinations of black and white bars that have been chosen so as to ensure that they are not easily confused with each other. Furthermore, the last digit of the barcode is a “checksum”, i.e. a digit that is calculated from the rest of the digits in order to check that what has been read is correct. For example a 12 digit UPC barcode actually has 11 digits that can be defined by the user followed by one check sum digit. The value of the checksum digit is found by: 3 times (sum of odd number digits, i.e. digits 1, 3, 5, 7, 9, 11)+(sum of the even number digits, i.e. digits 2, 4, 6, 8, 10)+the checksum is a multiple of 10. For example take the 11 digit number “00123456807”. Three times the odd numbers=3×(0+1+3+5+8+7)=72 and the sum of the even digits=(0+2+4+6+0)=12 so the sum of the two=72+12=84. The closest multiple of ten that is greater than 84 is 90. 84+6=90, so the checksum digit is 6. Therefore, the full 12 digit UPC barcode number is “001234568076”.

Furthermore, the thickness of the bars (whether white or black) may be chosen as integer multiples of each other, so if the narrowest bar in the barcode is 1 unit wide, the barcode can contain bars that 2 units wide and 3 units wide but cannot contain bars that are 1.5 units, or 2.5 units wide, for example. Assuming that the narrowest white bar is defined to be “0” and the narrowest black bar is defined to be “1”, then the number 5 in a 12 digit UPC barcode will be “0110001” (if it occurs before the midpoint of the barcode). This means that the number “5” is defined as the narrowest white bar, followed by a medium thickness black bar (two “1”s in a row, i.e. a black bar with the thickness of two of the narrowest black bars) followed by a very wide white bar (i.e. a white bar with the thickness of three of the narrowest white bars) followed by the narrowest black bar. This definition of the number “5” is distinctly different from the number “6” which is defined as “0101111” (when it occurs before the midpoint of the barcode). By defining numbers with distinctly different combinations of “0”s and “1”s it is unlikely that any number will be confused for any other number, also by having a checksum it makes the possibilities even more remote (since the checksum would also need to add up before the number is accepted as correct).

In the case where a barcode is misread (it could be damaged, for example, such that one bar is smudged and indistinguishable from the others). In normal existing applications, for example at a supermarket cashier's desk when a barcode is misread and the user (e.g. supermarket cashier) is required to key in the barcode number manually, the keyed-in number will be accepted as correct without any comparison to what was actually read by the scanner. However, in order to ensure that the positional data read by the scanner is correct, the scanned data may be stored and the keyed-in number is used to regenerate any missing (or incorrectly read) information or (important components) of the information (e.g. reference points). One assumption in regenerating barcode timing or positional data is that, over small distances, the speed at which the scanner moves with respect to the barcode does not change dramatically. In other words, although the scanning speed at the beginning and end of the barcode may be significantly different (because the distance between the beginning and end of the barcode is usually a few centimetres apart), across the distance of one narrow bar (which is typically about 200 micrometers wide) the speed of scanning would not change drastically. This assumption is generally valid since in order to change the speed over a small distance the acceleration needs to be extremely high. It is found that it is usually acceptable to assume that the speed over the width of a narrow bar (or even over a few bars) is linear (i.e. if it is known what is the speed at the start of the bar and the speed at the end of the bar it can be assumed that the speed in between these two points was a linear transition from the speed at the beginning of the bar to the speed at the end of the bar). For example, if the scanned data is missing a bar (it would be known it is missing that particular bar since the keyed-in information allows one to generate what the barcode should have been scanned as), it is possible to know the speed at the beginning of where the bar should have been and at the end and can estimate quite precisely where the middle point of the bar should have been. Similarly, this can be done if a few consecutive bars are misread or if various bars at different positions within the barcode have been misread by the scanner. In order to achieve this kind of regeneration it is essential to store information from the scan data (either the raw data itself or corresponding information, e.g. information about the position of the middle points or transition points of bars that have been read) and to compare it with what should have been read. This ability to regenerate barcode positional information makes our solution significantly more robust and commercially valuable, since the read signature can still be compared with the pre-stored reference signature even if the barcode is not read correctly.

If a barcode or some other form of machine readable serial number (or sequential information such as an alphanumeric code) is used as one set of identification features, the pre-stored reference signatures can be stored within a data storage medium using that serial number (or other sequential information) as a “primary key” (or index number) in order to quickly access that pre-stored reference signature (in a database the “primary key” is the main source for accessing information within the database). This means that the signature is only matched against the pre-stored reference signature corresponding to its serial number (or other sequential information). This allows signature matching to be done very quickly without having to try to match the incoming signature against all the pre-stored reference signatures in the database. This also decreases the chances of a false matching occurring since the incoming signature is not compared with other, irrelevant, pre-stored reference signatures.

FIG. 18 shows a similar embodiment to that shown in FIG. 3b. The difference is that FIG. 18 contains two sets of magnetic identification information. In FIG. 18, the strip of material 1800 contains magnetic identification features 1801 on its upper surface. The plane 1807 contains a second set of magnetic identification features. This plane is covered by a second material strip 1803. They are attached to either side of an item of value 1802 using methods described in relation to FIG. 3a. Once bonded together, the item of value as identified by the two sets of magnetic identification information, form an object according to the current invention. A reading device 1804, adapted to read the object, contains two magnetic reading elements 1805 and 1806 positioned so as to read the identification features 1801 and those contained within plane 1807 respectively. The magnetic identification features could, for example, be formed from writeable magnetic strips (such as used in credit cards), printed magnetic barcodes, or magnetic particles randomly dispersed in a non-magnetic matrix material. As an example the identification features 1801 would be formed from a writeable magnetic strip and the identification features contained in plane 1807 from magnetic particles randomly dispersed in a non-magnetic material. This concept is also applicable to non-magnetic identification features, for example both 1801 and those contained in plane 1807 could be randomly dispersed optically emitting particles.

FIG. 19 shows an embodiment that is similar to what is shown in FIG. 10a. In the case of FIG. 19 however, the identification features do not form linear tracks. In FIG. 19 an object 1901 (in this case the object is a label) contains an elliptical area of identification features 1902. The label is attached to an item of value 1904 which contains a triangular area of identification features 1903. The identification features could be read, for example by rastering the read elements simultaneously over each set of identification features, or by one linear sweep of read elements that are wide enough to cover the entire width of each area as they are swept over the identification features or by a read element (or group of elements) that is inherently able to “image” two dimensional areas, (such as an optical imaging device like a charge coupled device or a magnetic sensor array).

FIG. 20 shows a further embodiment of the present invention. FIG. 20a shows an object 2003 (in this case the object is a label) that is adapted to be attached to an item of value (not shown). The label comprises a rectangular-section piece of material 2000 containing a set of identification features 2001. The rectangular-section material has been attached to a film of material 2002 containing a second set of identification features 2004 (in this example a 1D barcode), and an area where further information can be printed 2005 (the information printed here need not be machine readable and need not be considered as “identification information” according to the definition given here, it can include information such as company name, logo, date of manufacture, batch and serial number and further information that may be read by a device separate from the invention or can be designed to be read by people). The label has an adhesive layer on its back surface (i.e. the surface not shown in the picture, opposite to the side containing 2000, 2004 and 2005).

FIG. 20b shows a reader 2010 adapted to read the object 2003 shown in FIG. 20a. The reader contains a reading element 2011 adapted to read the identification features 2001 and a second reading element 2013 adapted to read the identification features 2004.

It is also contemplated to carry out the measuring/sensing of only one set of the at least one set of identification features in certain circumstances where counterfeiting or tampering is not suspected. For example, if the object were a label, such as the one shown in FIG. 20a, it is likely that it would be supplied to the customer (in this case probably a manufacturer of items of value) in the form of labels stuck next to each other on a long roll of film that has been rolled into a reel of material (many labels are currently supplied in this format). Assuming in this case that it is the manufacturer themselves who are trying to prevent counterfeiting, it can be assumed that the labels used, and products manufactured, on their production line are genuine. Therefore, it is not necessary to check that the labels are genuine when they are attached to the products in the production line. In this case it may be advantageous to only read one set of identification information to identify the label that is being attached to the product. As an example, consider a reel of labels 2003 being used in a manufacturing facility. Before arriving at the manufacturing site, each label has had its identification features read and has its pre-stored reference signature stored in database, for example when the labels were being manufactured. The database would contain, for example, the serial number (i.e. number of the barcode printed on the label, corresponding to the barcode itself) of each label (hereafter called the “label number”) and the corresponding pre-stored reference signature of the identification features 2001 for that particular label. On the manufacturing line, it can be advantageous to print human readable information on the area 2005, such as the batch and serial number of the product the label is being attached to (this would allow the label to be read without a reading device and connection to the database storing the label numbers and pre-stored reference signatures). It is advantageous to store the information that is printed on the label at the manufacturing line on the database together with the label number and its pre-stored reference signature. It is also advantageous where the production process permits, for the product serial number to be the pre-printed label serial number. This can be achieved by reading the label number (without necessarily needing to read the label's signature) just prior to, or immediately after, the additional information is printed onto the label.

In a fast production line, this information may be read from a 1D or 2D barcode using a non-contact laser scanning barcode reader, or if the serial number is stored on a RFID chip, by reading the data using a RFID reader. The identification information, such as magnetic particles distributed randomly in a non-magnetic material, for example, would usually require a slower contact-based reading. Reading such information could potentially slow down the production line and make the system more prone to mechanical jamming (since contact reading devices are more prone to jamming than non-contact ones). Furthermore, it is unnecessary to read the signature again since it has already been stored in the database and in this example, being a legitimate production line, the label's authenticity is not of concern at that juncture.

These sets of information are then sent to the database that already stores the label number and pre-stored reference signature. These sets of information are linked in the database so that when the database is queried using the label number, the label's other information is associated with it. Additional information can also be stored in the database and associated with these three sets of information, for example the time and date when the product was manufactured, who the product was or will be sold to, the product expiration date, the geographical extent of its warranty, etc.

By having a label number associated with the label, it is also easy to remove or flag labels in the database that have been lost, stolen or damaged. For example, if a reel of labels is reported as lost, those labels can immediately be “deactivated” from the database by simply putting a flag in the data record which indicates that they are suspect. If such a label were read subsequently, the holder or user of the database could immediately be alerted that the label was supposedly destroyed (for example) and the database system could return an error message to the reading device to state that the label is suspicious. This kind of alert system is also very useful for issues such as product alerts or recalls or information that becomes available about the product after it has been shipped from the factory. A flag in the database can allow the database to return any new pertinent information about the label back to the reading device immediately once a label has been read.

FIG. 21 depicts one method for normalizing the data obtained from separate readings of the same object. In this example, the object has two sets of identification information, the first set being a 1D barcode and the second set being derived from randomly dispersed magnetic particles. “Barcode Reading 1” shows the data obtained from a first reading of the barcode (the peaks represent the data from the sensor when a black bar is detected and the troughs represent the data from the sensor when a white bar is detected). “Magnetic Reading 1” shows the data that is obtained from a simultaneous first reading of the magnetic identification information. The term ‘simultaneous’ as used herein has been defined above. The X axis of the data represents time from when the first data point was obtained and the Y axis represents the strength of the signal read from the sensors (so the barcode data represents the strength of the signal from the barcode sensor and the magnetic data represents the strength of the data obtained from the magnetic sensor). Since the data is read simultaneously by the same microprocessor, corresponding data from “Barcode Reading 1” and “Magnetic Reading 1” are from corresponding positions along the sets of identification information. For example, it is possible to take one datum from the barcode sensor and take a corresponding datum the magnetic sensor at the same instant. In a microprocessor, it is quite usual for it to be able to take readings within microseconds of each other—e.g. an ATMEL AT91SAM7S64 microprocessor for example is able to acquire data points from its analogue to digital converter (ADC) every 2.4 microseconds, which for most purposes can be considered as instantaneous or simultaneous, i.e. at the same time. Then, for example, datum point number 300 acquired from the barcode sensor was acquired at the same time as datum point number 300 of the magnetic signal was acquired from the magnetic sensor.

In the above discussion, data points were taken from corresponding relative positions along the sets of identification features. By using an object configured as shown in FIG. 1a together with a reader configured as shown in FIG. 1c, the relative positions of the barcode sensor and magnetic sensor with respect to the barcode identification features and magnetic identification features are fixed. The reading elements in the reading device are arranged such that they scan at specific positions on the object corresponding to where each set of identification information would be located. By fixing the position of the reading elements in the reading device, data points having the same time values (i.e. data points that are read at the same instance) are taken to correspond to each other. In other words, a datum point read from the barcode and the datum point taken at the same time by the magnetic sensor will be taken to be from corresponding positions along the barcode and magnetic identification features respectively (obviously within certain tolerances).

The above method of matching datum points that have the same time values enables data that is obtained simultaneously by the barcode sensor and the magnetic sensor to be correlated directly, so that simultaneously read datum points can be assumed to be from corresponding positions along the barcode/magnetic identification information, as is shown in FIG. 21a. This correlation allows data taken from separate readings of the same object to be mapped to the spatial domain (i.e. the data plotted against its physical position on the object) by using positional reference points and compared—i.e. signatures derived from separate readings can be compared to each other.

In FIG. 21a, the middle points of the white bars are used as positional reference points. The dashed lines shown in FIG. 21a correspond to the middle points of the white bars (i.e. the minima in the Barcode Readings shown). In Barcode Reading 1 and Magnetic Reading 1, the data is in the Time Domain (i.e. the data plotted against the relative time at which it was read) and the first data point is obtained at time “0” and the last data point is obtained at time “T₁”. “Spatial Mapping 1” of the magnetic data is achieved by using the positional reference points to map the magnetic data obtained to a “standard” Spatial Domain. The standard Spatial Domain is what the magnetic data looks like if the magnetic data is plotted against its relative position instead of its relative time. Since the positions between the two sets of identification information are relative, the beginning position of each magnetic reading may be standardized to be “0” units and ending at a position to be “1” unit (as shown in the “Spatial Domain” area of FIG. 21a). In this case the beginning position of the magnetic reading is always taken to coincide with when the first positional reference point is obtained from the barcode reading and the ending position coincides with where the last positional reference point is obtained. Since the barcode is known, the relative location of the positional reference points along the length of the barcode in the Spatial Domain is also known. If a piece-wise linear mapping method is used, it may be assumed that the speed that the reader moved between two adjacent positional reference points was linear. So if the time at which the first reference point was detected was taken as time “0” (as shown in the FIG. 21a) and the next reference point was detected at time “H”, but that reference point is known to be “J” units from the first reference point (since the barcode number is known, the middle points of the bars should also be known), then all the times of the data taken should be mapped between the start of the reading and the first positional reference point to their corresponding spatial positions by using the following equation:

spatial position of datum=t(actual time that datum point was acquired)×J/H.

Data obtained between subsequent reference points is mapped in a similar piece-wise linear fashion using equations appropriate to the individual datum's time/position along the reading. The mapping of Magnetic Reading 1 using the reference points obtained from Barcode Reading 1 is represented graphically in FIG. 21a by the operation “Spatial Mapping 1”. This Spatial Domain data for Magnetic Reading 1 represents the signature read from the data in the first reading of the object, shown graphically in FIG. 21a as “Signature 1”. This can be stored in the database as the pre-stored reference signature for the object, i.e. the database can contain at least the barcode number used as the data's primary key and Signature 1 which can be the pre-stored reference signature against which subsequent readings are compared

Data obtained from a subsequent reading of the object is shown graphically as “Barcode Reading 2” and “Magnetic Reading 2”. This reading starts at relative time “0” and finishes at relative time “T₂”. “Spatial Mapping 2” shows graphically how the data is mapped to the same standard “Spatial Domain” as Signature 1 using a similar piece-wise linear method as described for Spatial Mapping 1. The magnetic data mapped to the standard Spatial Domain now comprises a second signature read from the object (shown in the figure as “Signature 2”). In this example, a unique barcode number is assumed to be used for every object, therefore the read barcode number can be used to ensure that the object is authenticated by comparing Signature 2 with Signature 1 only (which is being used as the pre-stored reference signature for the object), i.e. the read signature need only be compared with the pre-stored reference signature associated with the same barcode number. Obviously if many objects have the same barcode number then the incoming signature needs to be compared with all the pre-stored reference signatures associated with its barcode number to see which one matches and thereby identify which object it is. This situation, i.e. where many pre-stored reference signatures may be associated with the same barcode number may be used, for example, if products are marked by batch, i.e. one batch of many products would have the same barcode number, but the individual items would have different signatures.

Although the example given above describes a piece-wise linear mapping, it is also possible to consider using any relevant mapping method, for example polynomial based mappings, spline mappings etc. Furthermore in certain cases it may be useful to normalize the intensities of the read magnetic data too (i.e. the Y axis), an example of a simple way to do this would be map the intensity of the data to a standard “0” to “1” interval, where for each reading the lowest (Y axis) datum read is mapped to a value of “0” and the highest is mapped to a value of “1”, this could be done again by using a linear mapping (or any other appropriate mapping) of the data to this standard.

To illustrate how an interpolation function may be used to model a signal or a signature as illustrated in FIG. 21a, the following example is described. One method to interpolate between reference points (e.g. middle points of bars in a barcode) is to fit a curve (e.g. a polynomial) to the reference point data read, i.e. the curve will model the time at which the reference points are read versus the distance traveled by the reading element between the reference points. For example, using interpolation, discrete data of the signals are fitted to a curve. Once the curve (i.e. mathematically described function) is obtained it can be used to predict the time versus position at points other than the reference points. For example, consider a simple case where 4 reference points are each spaced 1 unit apart. The first unit is read (or recognized) by the reader at time (“T”)=0, the second at T=1 unit, the third at T=4 units and the last at T=9 units. The data can be fitted to a mathematical function of X=T̂0.5 (where X is the distance traveled from the first reference point). With this equation, it is possible to predict the how far the reader would have traveled at arbitrary times between the times where the reference points are read. For example by time of T=1.5 units it would have traveled a distance of (1.5)̂0.5=1.225 units from the first reference point. This interpolation allows data modelling where magnetic data (for example) was read with respect to the reference points that are read.

FIGS. 21b, 21c and 21d depict various readings obtained from an identification tag as shown in FIG. 1a. As shown schematically in FIG. 21b(i), the first set of identification information comprises a barcode and the second set of identification information comprises an identification layer comprising randomly distributed magnetic particles (hereinafter ‘magnetic layer’). Reading of the barcode yields a first signal (hereinafter ‘barcode signal’) as represented by A_{bar} showing the positions of the black bars and white spaces on the barcode. Reading of the magnetic layer is carried out simultaneously as the reading of the barcode is being carried out, and the reading yields a second signal (hereinafter ‘magnetic signal’) comprising discrete values A_{mag} representing the magnitude of the magnetic field strength along a portion of the magnetic layer. By correlating values in the first signal to values in the second signal which were read at the same time, it can be seen that the black bars act as reference markings to mark out specific values in the magnetic signal. This allows specific points in the magnetic signal to be associated with the black bars in the barcode, thereby enabling a selection of values in A_{mag} to be made. It is the selected values A_{signature} that forms the signature. This signature uses the relative spatial position between identification features in the barcode and identification features in the magnetic layer based on which an object is to be identified according to one embodiment of the invention. Apart from verifying the signature against a pre-stored reference signature, it is also possible to match individual read signals, i.e. either the magnetic signal or the reflectivity signal from the barcode, against stored respectively authenticating magnetic or reflectivity signals.

Several scenarios exist in which the signature that is derived from read data does not form a match with its corresponding pre-stored signature. FIG. 21b(ii) depicts a read barcode signal R_{bar} that is obtained from the same barcode but which has been misaligned with respect to the magnetic layer, in particular, shifted upwards. This situation could occur if the barcode was removed from its original position and then re-attached to the object. Due to the change in the position of the barcode, the five black bars in the barcode mark out a totally different set of values in a read magnetic signal R_{mag}, resulting in a read signature that differs entirely from the pre-stored reference signature. FIG. 21c depicts a situation in which the barcode is properly realigned against the magnetic layer but has one of its bars misaligned. The misaligned bar is then correlated to a value in the read magnetic signal R_{mag} that differs from that in A_{signature}, resulting in a non-matching read signature. This situation, i.e. having one or more bars misaligned could occur if the barcode was on a film of material that was stretched or crumpled during reattachment. FIG. 21d depicts a situation in which the magnetic layer is forged and the signal that is derived from it does not fully match the signal A_{mag}. Although the barcode and the magnetic layer are aligned quite well, the black bars in the barcode point to correct locations on the magnetic layer, but these locations exert magnetic field strength values which differ from those in A_{signature}, thus resulting in a non-matching signature.

FIG. 22a shows one method by which signatures (the pre-stored reference signature and a read signature that is to be matched against the pre-stored reference signature) can be compared with each other to see if they match or not. Portions of two signatures are shown; the portions both contain one peak in a similar position and height. The area under the peak of the pre-stored reference signature is shown as “Area A_{ref}” while the area under the read signature is shown as “Area A_{read}”. The area under each peak can be readily calculated using simple numerical integration methods such as the trapezoid method. Area A_{ref} overlaps with Area A_{read} as shown by “Area Aₒᵥₑᵣ”. One method to compare the data is to see how much overlap area there is compared with the total area under the two peaks using the equation:

Comparison Value=2×Area Aₒᵥₑᵣ/(Area A_{ref}+Area A_{read})

If there was a perfect match between the peaks (i.e. they are exactly the same with respect to both the X and Y axes), the Comparison Value would equal 1 whereas if there was no match at all, i.e. there was no overlap, then the Comparison Value would equal 0. This concept can be extended to entire graphical representations of signatures (i.e. not just one pair of peaks) by having “Area A_{ref}” equal to the area under all peaks in the pre-stored reference signature and “Area A_{read}” being the area under all peaks in the read signature and “Area Aₒᵥₑᵣ” equal to the total area of overlap of all peaks. A predetermined threshold Comparison Value is used to decide whether the signatures match or not, for example if the threshold Comparison Value is chosen to 0.9, then if the calculated Comparison Value is above 0.9 the signatures are determined to be matching signatures (i.e. the object's identity is verified) whereas if the calculated Comparison Value is below this, the signatures do not match according to the criterion and the object is not authenticated by the system.

In an illustrative example to show an application of the invention, an identification tag was affixed with a UPC 12 barcode and a magnetic layer having randomly distributed magnetic particles as shown in FIG. 1a. The reflectivity signal of the barcode and the magnetic field strength signal of the magnetic layer were read. The signal strengths of the barcode and the magnetic strip were plotted against time (time domain data). By transforming the time domain data into spatial domain data according to the methods described in relation to FIG. 21, wherein the barcode signal was used as the positional reference to normalise the magnetic field strength signal, a signature was obtained and stored as the pre-stored reference signature. Subsequently, a similar procedure was carried out on the same identification tag without any alterations to the identification tag (but with a purposeful minor misalignment of the reading elements with respect to each other) to obtain a read signature. Both signatures were plotted on the same set of axes and compared. As can be seen from FIG. 22b, the peak of the read signature 2201 matched the peak of the pre-stored reference signature 2202 with a misalignment of about 100 μm as shown in the exploded portion of a peak. Therefore the relative spatial position can be determined with an accuracy of about 100 μm or better. The accuracy of a match may be further improved to less than 100 μm, or less than 50 μm, or even less than 25 μm by using reading devices with high resolutions.

The above method is a simple but effective matching algorithm for certain types of data. In the literature, many different ways of signal recognition, pattern recognition or data matching are described, e.g. using wavelets and other spectral methods. The effectiveness of the matching method depends on the type of data being matched. Ideally, a matching algorithm should be chosen based on the expected form of the data (signature) and with knowledge of the strengths and weaknesses of the reading device. For example, a reading device may be very accurate in its spatial resolution but the intensity of the read signal may vary with temperature. For this reason, greater weight (or importance) may be placed on the fact that positions of peaks (or any other identification features characteristic of the signal) match with each other rather than the actual intensities of the peaks. Some of the inventors' experiments with certain devices reading magnetic and barcode signals, for example, are better in spatial matching than in intensity matching, as the magnetic fields decay very quickly if the magnetic sensor is not in close contact with the object during the entire reading. Thus, although the magnetic peak is clear, its intensity may not match a previous reading perfectly, whereas its position would match well.

FIG. 23 shows an object according to a further embodiment of the present invention. FIG. 23a shows an isometric view of the object, while FIG. 23b provides a cross-sectional view as seen from the object's front face (i.e. front face shown in the isometric view). Here a plane 2307 containing randomly distributed magnetic particles is embedded into an item of value 2302. The plane intersects the top surface of the object exposing a track of identification features 2301. The plane also intersects a sidewall of the object, exposing a second track of identification features 2304. Even though the identification features 2301 and 2304 are contained within the same plane of material 2307, they are exposed by, and read from, different surfaces of the object, therefore they are, according to our definition “contained” or “arranged” within different surfaces of the object. In this embodiment, the material plane could be broken in the centre and the identification features could still be meaningfully read.

Various exemplary methods of fabricating identification tags having an identification layer or forming identification layers directly onto an object will be described in the following.

FIG. 24A to FIG. 24D show a process which may be used to produce such tags or objects. Firstly, as shown in FIG. 24A, nickel flakes 2400 are brushed onto the glue containing side of a polymeric laminating sheet 2401. Then, as shown in FIG. 24B, another laminating sheet 2402 is overlaid and the stack of material is laminated together by passing the stack through a conventional office-stationary laminator at 110° C. and the lowest preset speed (speed 1). The edge cross-section is then polished to ensure that a smooth surface containing a track 2403 of the identification layer is exposed, as shown in FIG. 24C. This edge can then be read using a magnetic field sensor to provide a signal 2404, as shown in FIG. 24D, in which the particles cause peaks in the magnetic field that then coincide with peaks in the signal. Suitable magnetic field sensors include inductive heads, AMR heads, GMR heads and magneto optical Kerr effect detectors. The process for manufacturing tags or objects of the invention illustrated in FIG. 24F to FIG. 24H is identical to the one of FIG. 24A to FIG. 24D with the exception that elongated nickel flakes or fibres or whiskers that are arranged in the plane of the identification layer are used. Because of the different size and shape of the nickel flakes, the signal 2404 that is obtained from reading the track is of course different from the one in FIG. 24D. The elongated shapes give the added advantage that the magnetic signal detected from the track is a substantially out-of-plane magnetic signal, making the signal easier to detect and the tag even harder to forge.

The tags or objects of the invention can be manufactured easily in not only in a batch process, as described here, but also in a roll-to-roll process. FIG. 25 illustrates a roll-to-roll process for manufacturing these tags or objects, including a roll 2501 of one-sided polymer laminate. In such a case, the rate of the roll process and the pulsed deposition of particles from a particle dispenser 2500 define the lengths of and spaces between each set of identification information. After having passed a circular brush 2502, rolls 2503 for stamping/pressing are passed, followed by laminating rolls 2505 which may work at a temperature of, but not limited to, 110° C. Further, a waste path 2504 is provided for any edge trimming that is performed. By including a polishing device 2506 after pinch rollers 2510, and a reading/indexing device 2507, it is possible to manufacture these tags or objects, read and index them in line, and spool them on to reels ready for use for the purpose in high volume and at low cost. At the end, a finished polymer roll 2508 is produced, perhaps on a second carrier film or backing roll provided by 2509. By indexing, it is meant that when a tag is dispensed from the reel, it is known which tag was read and has an existing pre-stored reference signature.

Referring to FIG. 26, an optional step for manufacturing an identification tag according to a third embodiment of the invention will be described. As shown in FIG. 26, it is also possible to produce a wide web of laminate 2600 and cut into strips using a cutting device 2601 so that a number of identification layers 2602 become exposed and can be individually polished, read, indexed and stored for later use indicated by arrows 2603.

In the following, referring to FIG. 27, views during a method for manufacturing an identification tag according to one embodiment of the invention will be described. FIG. 27A to FIG. 27E illustrate an exemplary process of preparing a laminated tag using aluminum foil 2700 shown in FIG. 27A. Firstly, the aluminium foil 2700 is cleaned with lint free wipes together with isopropanol (IPA) followed by deionised water. Then, as shown in FIG. 27B, the foil 2700 is placed in between two polymeric laminating sheets 2701, 2702 so that it is in contact with the glue sides, wherein a portion of the foil 2700 is protruding out. The stack of material, as shown in FIG. 27C, is laminated together by passing it through a conventional office-stationary laminator at, for example, 110° C. and lowest pre-set speed (speed 1). Then the laminated film 2703 is mounted into epoxy mold 2704 using Struers EpoFix and left to cure, as shown in FIG. 27D for example over night. The last step of preparation is a two-step polish. The sample is consecutively polished with polishing paper from grade 500 to 1200 to 2400 to 4000, followed by a fine polish using diamond suspensions with 3-micron beads and 1-micron beads. FIG. 27E shows the bottom view of the laminated A1 film prepared in this way.

Next, as shown in FIG. 28, the sample and a Pt mesh 2801 are placed into a beaker 1500, and the temperature of a cold plate 2802 is set to the desired temperature of for example 4° C. using a thermal control device 2802. When the temperature of the solution reaches the set temperature, the power supply 2803 set to 150 V is connected as shown, using the protruding foil 2700 as a contact for the tag precursor. This anodizing process creates disordered porous alumina with pores randomly distributed in the edge of the aluminum containing layer. Following this, the sample is placed into the widening solution (for example, 5 wt % phosphoric acid), to enlarge the pores to a desired size. Finally, the sample and Pt mesh 2801 are placed in a Ni plating solution containing 30 g NiSO₄.6H₂O, 4.5 g NiCl₂.6H₂0 and 4.5 g H₃BO₃. The plating voltage is set at −1.4 V, for example. After plating, Ni is randomly filled inside the pores. This region now constitutes the desired identification layer.

FIG. 29 provide views during an exemplary method for manufacturing an identification tag according to the above-described embodiment of the invention, showing the pore forming and pore filling method steps. FIG. 29A shows a portion of the aluminium foil 2700 between the laminating sheets 2701, 2702. FIG. 29B shows the array of FIG. 29A after an anodizing method step, so that pores 2900 are formed in the aluminium foil 2700. FIG. 29C shows the array of FIG. 29B after a nickel plating method step, so that nickel particles 2901 are formed in some of the pores 2900 of the aluminum foil 2700. FIG. 29D shows a signal 2910 captured by a reading element on the identification tag shown in FIG. 29C. Therefore, FIG. 29A to FIG. 29D illustrate the process of forming a tag containing an identification layer. As described for the case above using the magnetic particles in a laminate, this identification layer (or, more accurately, the identification features contained therein) can now be read from the track of the identification layer using a suitable magnetic field detector.

Finally, FIG. 30 illustrates a method 3000 of identifying an object having identification information, wherein the identification information is used to verify the identity of the object. The method comprises a step 3002 in which providing an object is provided having at least two sets of identification information. This object comprises a first set of identification information and a second set of identification information, wherein at least one identification feature of the first set of identification information is arranged on, or incorporated within, a different surface, side or plane of the object, with respect to at least one identification feature of the second set of identification information. Thereby the object is adapted to be identified. The at least one identification feature of the first set of identification information and the at least one identification feature of the second set of identification information are arranged at a fixed relative spatial position with respect to each other, said fixed relative spatial position being used to derive a signature for identifying the object.

The method comprises a step 3004 in which a reading device is provided. This providing step 3004 can be carried out before or after the step 3002. The reading device is adapted to read a signal from the at least one identification feature of each of the at least two sets of identification information arranged on, or incorporated within, different surfaces, sides or planes of the object. In addition, the reading device is configured such that it defines the spatial relationship between a first discrete area of the first set of identification information to be read and a second discrete area of the second set of identification information to be read. Using the reading device at least one characteristic of a property of the at least one identification feature of the first set of identification features is determined in a step 3006. Thereby a first signal is obtained. Using the reading device at least one characteristic of a property of the at least one identification feature of the second set of identification features is determined in a step 3008. Thereby a second signal is obtained. The steps 3006 and 3008 can be carried out simultaneously or sequentially in any desired order. Then, using said first and said second signals, in step 3010 at least one signature for the object is derive by means of processing unit.

Although this invention has been described in terms of preferred embodiments, it has to be understood that numerous variations and modifications may be made, without departing from the spirit and scope of this invention as set out in the following claims.

1. A method of identifying an object having identification information, said identification information being used to verify the identity of the object, said method comprising:
providing an object having at least two sets of identification information comprising a first set of identification information and a second set of identification information, wherein at least one identification feature of the first set of identification information is arranged on or incorporated within a different surface, side or plane of the object, with respect to at least one identification feature of the second set of identification information, thereby adapting the object to be identified,
wherein said at least one identification feature of the first set of identification information and said at least one identification feature of the second set of identification information are arranged at a fixed relative spatial position with respect to each other, said fixed relative spatial position being used to derive a signature for identifying the object,
providing a reading device, wherein said reading device is adapted to read a signal from the at least one identification feature of each of the at least two sets of identification information arranged on or incorporated within different surfaces, sides or planes of the object, and wherein the reading device is configured such that it defines the spatial relationship between a first discrete area of the first set of identification information to be read and a second discrete area of the second set of identification information to be read, and
determining, using the reading device, at least one characteristic of a property of the at least one identification feature of the first set of identification features, thereby obtaining a first signal,
determining, using the reading device, at least one characteristic of a property of the at least one identification feature of the second set of identification features, thereby obtaining a second signal,
using a processing unit to derive at least one signature for the object, using said first and said second signals.

2. The method of claim 1, wherein the first set of identification information and/or the second set of identification information comprises an optically readable pattern.

3. The method of claim 2, wherein the first set of identification information comprises a barcode symbol.

4. The method of claim 1, wherein the first set of identification information and/or the second set of identification information each comprise at least one identification layer in which readable identification features are located.

5. The method of claim 4, wherein said at least one identification layer comprises, at least in part, a plurality of randomly distributed particles.

6. The method of claim 5, wherein said at least one identification layer comprises a plurality of randomly distributed magnetic or magnetisable particles.

7. The method of claim 6, wherein reading the at least one identification feature of the first set of identification information and/or the second set of identification information comprises reading the magnetic field strength of a portion of the identification layer.

8. The method of claim 4, wherein said at least one identification layer comprises a plurality of randomly distributed conductive and/or semi-conductive particles.

9. (canceled)

10. The method of claim 4, wherein the identification layer comprises a host material selected from the group consisting of metals, ceramics, polymers, naturally occurring organic materials and combinations thereof.

11. The method of claim 10, wherein the material is a magnetic material selected from the group consisting of Fe, Ni, Co, their alloys, oxides, mixtures and combinations thereof.

12. The method of claim 4, wherein the average particle has a largest dimension of between about 10 nanometres and about 500 micrometers.

13. (canceled)

14. The method of claim 1, wherein the object is an item of value or an identification tag.

15. The method of claim 1, wherein the object is an item of value to which an identification tag is attached, wherein at least one set of identification information is provided on the identification tag and the second set of identification information is arranged on the item of value.

16. The method of claim 1, wherein the first set of identification information is arranged on a first surface of the object and the second set of identification information is arranged on a second surface of the object.

17. The method of claim 14, wherein the first set of identification information is arranged on a first surface of the identification tag and the second set of identification information is arranged on a second surface of the identification tag.

18. The method of claim 14, wherein the first set of identification information is arranged on a first side of the object and the second set of identification information is arranged on a second side of the object, said first side and second side being in the same plane.

19. The method of claim 14, wherein the first set of identification information and the second set of identification information are arranged to form a layer arrangement.

20. The method of claim 19, wherein the first set of identification information is arranged as a first layer and the second set of identification information is arranged as a second layer in said layer arrangement.

21. The method of claim 14, wherein the first set of identification information is arranged on a surface of a tag that is arranged on the object and the second set of identification information is arranged in a plane within the tag.

22. (canceled)

23. The method of claim 1, wherein the property of the at least one identification feature of each of the first and the second sets of identification information being determined each comprise a physical property independently selected from reflectivity, magnetic field strength, luminescence, and electric field strength.

24. The method of claim 1, wherein the first signal is obtained as a function of time, thereby obtaining a set of first time domain data values.

25. The method of any of claim 1, wherein the second signal is obtained as a function of time, thereby obtaining a set of second time domain data values.

26. The method of claim 24, wherein data from the first signal and/or the second signal is acquired with respect to time, i.e. in the time domain, or with respect to a relative position, i.e. in the spatial domain, and said data is normalized or a mathematical function is fitted to said data.

27. The method of claim 26, wherein the normalization or fitting function comprises an interpolation function.

28. The method of claim 26, wherein the normalization or fitting function comprises an extrapolation function.

29. The method of claim 27, wherein the normalization or fitting function is selected from a group consisting of a linear function, a polynomial function, a spline function, a spectral function, such as a wavelet or Fourier function, and a multivariate function.

30. The method of claim 26, wherein the normalization or fitting of the first set of data and/or the second set of data is carried out by the processing unit.

31. The method of claim 1, wherein the relative speed between the reading element and the identification features, and/or the scanning speed, during said reading is used to determine the sampling rate of the processing unit for acquiring data from said reading.

32. The method of claim 1, wherein the at least one identification feature of the first set of identification information and the at least one identification feature of the second set of identification information are read simultaneously.

33. The method of claim 1, further comprising storing the at least one said signature using a data storage medium, thereby generating at least one pre-stored reference signature.

34. The method of claim 24, wherein deriving a signature using said first and said second signals comprises
determining reference features from the first signal data,
using said reference features to normalize or map the second signal data to a standard spatial domain (or standard time domain which can be associated with the relative position of the reference features), thereby obtaining a signature for identifying the object.

35. The method of claim 34, wherein the standard domain that data is mapped to is different for each object.

36. The method of claim 33, wherein the signature that is being stored as the object's pre-stored reference signature is used to determine the standard spatial or time domain for that object and wherein subsequently read signatures are mapped to that standard domain in order to be compared with the object's pre-stored reference signature.

37. The method of claim 1, further comprising verifying the identity of the object.

38. The method of claim 37, wherein verifying comprises
checking a read signature against the at least one pre-stored reference signature.

39. The method of claim 38, further comprising checking the values of data for the first signal against values for the first signal that are either stored or known.

40. The method of claim 38, further comprising checking the values of data for the second signal against the values for the second signal that are either stored or known.

41. The method of claim 40, wherein said verifying comprises
obtaining a graph or mathematical function representing the read signature,
checking said graph or mathematical function of the read signature against a graph or mathematical function representing the pre-stored reference signature, and
determining the degree of overlap or similarity between the graph or mathematical function of the read signature and the pre-stored reference signature.

42. The method of claim 38, wherein the object's identity is verified if the values of data for the read signature differ from the corresponding values pre-stored reference signature by less than a predetermined threshold.

43. The method of claim 37, wherein the pre-stored reference signature is stored in a data storage medium that is accessible remotely.

44. (canceled)

45. The method of claim 1, further comprising
storing the first signal and the second signal in a data storage medium.

46. The method of claim 1, wherein the object has one or more further sets of identification information, and wherein identification features of said further set of identification information are arranged at a fixed further relative spatial position to identification features of said first and/or said second set of identification information.

47. The method of claim 46, wherein the fixed further relative spatial position is used to form a signature for identifying the identity of the object.

48. The method of claim 31, wherein a first set of identification information comprises a standard format and wherein the speed between the reading element and said first set of identification information, and/or the scanning speed, is determined by the reading device.

49. The method of claim 48, wherein information about the speed, derived from reading the first set of identification information by the reading device, is used to control the sampling speed for acquiring data from a second set of identification information.

50. The method of claim 33, wherein the more than one pre-stored reference signatures are derived from reading the object using at least two different reading devices.

51. The method of claim 50, wherein the at least two reading devices have an inherent or purposefully designed difference between them, and where said difference affects the reading and consequently the associated signature.

52. The method of claim 33, wherein a subsequently read signature is compared with all of the pre-stored reference signatures associated with the object or associated with a family of objects.

53. The method of claim 33, wherein a subsequently read signature is compared with all of the pre-stored reference signatures in the database.

54. The method of claim 33, wherein a serialized identification information is used as one of the at least two sets of identification features and wherein the processing unit is adapted to regenerate data or important components missing from part(s) of the read signal, if the reading device does not fully, completely or correctly read said serialized identification information.

55. The method of claim 54, wherein the data or important components missing from part(s) of the read signal is regenerated or can be estimated based on supplementary information that is keyed in or scanned in separately, said supplementary information relating to the identification information that has not been fully or correctly read.

56. The method of claim 55, wherein said regenerated data or components are used to form a signature for identifying said object.

57. The method of claim 33, wherein a serialized identification information is used as a primary key with which to store and retrieve a pre-stored reference signature in the database.

58. The method of claim 54, wherein the serialized information is a barcode, a serial number, binary or hexadecimal information, or an alphanumeric code that has been assigned to the object.

59-90. (canceled)
